(19) United States
(12) Patent Application Publication
(10) Pub. No.: US 2022/0293934 A1
(43) Pub. Date: Sep. 15, 2022

(54) COMPOSITE ELECTRODE HAVING A SOLID ELECTROLYTE BASED ON POLYCARBONATES

(71) Applicants: COMMISSARIAT A L'ENERGIE ATOMIQUE ET AUX ENERGIES ALTERNATIVES, Paris (FR); SAFT, Levallois-Perret (FR)

(72) Inventors: Huu-Dat NGUYEN, Grenoble cedex (FR); Lionel PICARD, Grenoble cedex (FR)

(73) Assignees: COMMISSARIAT A L'ENERGIE ATOMIQUE ET AUX ENERGIES ALTERNATIVES, Paris (FR); SAFT, Levallois-Perret (FR)

(21) Appl. No.: 17/654,089

(22) Filed: Mar. 9, 2022

(30) Foreign Application Priority Data
Mar. 9, 2021 (FR) 21 02254

(51) Int. Cl. H01M 4/525; H01M 4/36; H01M 4/505; H01M 4/485; H01M 4/62; H01M 4/1391; H01M 10/0565; H01M 10/052

(52) U.S. Cl. CPC H01M 4/525; H01M 4/362; H01M 4/505; H01M 4/485; H01M 4/625; H01M 4/622; H01M 4/1391; H01M 10/0565; H01M 10/052; H01M 2300/0082; H01M 2300/0085

(57) ABSTRACT

A composite electrode with a solid electrolyte based on polycarbonates includes at least one solid electrolyte consisting of one or more (co)polymers obtained by ring-opening (co)polymerization (ROP) of at least one five- to eight-membered cyclic carbonate and, optionally, of at least one five- to eight-membered lactone, catalyzed with methanesulfonic acid or performed under microwave irradiation in the absence of catalyst. The hydroxyl functions at the end of the chain of the (co)polymer(s) may be protected. The electrode also includes at least one alkali metal or alkaline-earth metal salt and at least one electrode active material. The electrode may include one or more electrically conductive additives and/or one or more binders. The electrode may be used in an electrochemical system such as a lithium battery.

### TECHNICAL FIELD

The present invention relates to a composite electrode for an electrochemical device, in particular an electrochemical cell, notably a lithium battery, to an electrochemical device comprising the composite electrode, and to a process for preparing such a composite electrode.

More particularly, the invention relates to a composite electrode incorporating a solid electrolyte consisting of one or more aliphatic polycarbonates, made conductive by dissolving at least one alkali metal or alkaline-earth metal salt, in particular a lithium salt. The polycarbonates used to form the solid electrolyte incorporated into a composite electrode according to the invention are synthesized by ring-opening (co)polymerization (ROP) under specific conditions, using methanesulfonic acid (MSA) as catalyst or, alternatively, in the absence of a catalyst under microwave irradiation.

### PRIOR ART

Conventionally, the operating principle of an electrochemical generator is based on the insertion and the removal, also known as the deinsertion, of an alkali metal ion or of a proton, into and from the positive electrode, and the deposition or extraction of this ion, onto and from the negative electrode. The main systems use the lithium cation as ion transport species. In the case of a lithium accumulator, for example, the lithium cation extracted from the positive electrode during the charging of the battery becomes deposited on the negative electrode, and conversely, it is extracted from the negative electrode to become inserted in the positive electrode during discharging.

The electrochemical cell, for example of a lithium accumulator, is thus conventionally formed from a negative electrode and a positive electrode, separated by an electrolyte (known as the separating electrolyte). Each of the positive and negative electrodes is in contact with a current collector, which transports the electrons to an external electrical circuit. Depending on the type of accumulator, the separating electrolyte may be in solid, liquid or gel form.

Electrodes for lithium batteries are volume electrodes where the electrochemical reaction is distributed in the electrode volume on the surface of the active material particles. The electrodes are complex composite materials generally obtained by mixing a powder of an electrochemically active material with electrically conductive additives such as carbon black and a polymeric binder. This highly complex medium must be a mixed conductor of both Li⁺ ions and electrons, so that these reagents are delivered as efficiently as possible to each of the grains of the active material.

Composite electrodes are generally formed by coating an ink comprising the powdered electrochemically active material, a binder and an electrically conductive additive, dispersed in an organic or aqueous solvent, onto a current collector.

The polymeric binder must provide the electrode with cohesion of the various components and mechanical strength on the current collector. It is also desirable for it to give the electrode a certain amount of flexibility for use in the cell, for example with respect to a winding step.

The electrochemically active materials used in a composite electrode may also exhibit high volume expansion during lithiation. This expansion can lead to degradation of the electrode integrity and fracturing of the electrode-electrolyte interface.

To prevent electrode degradation and to improve the electrochemical performance of batteries, many studies have focused on the nature of the binder. The polymeric binders used to date in lithium batteries include, for example, polyvinylidene fluoride, carboxymethylcellulose, nitrile rubber, styrene-butadiene rubber and polyacrylic acid ([1], [2]).

With the development of intrinsically conductive or gelled polymer electrolytes, polymer electrolytes have also been proposed as a binder for composite electrodes, which notably makes it easier to accommodate variations in the volume of electrode materials ([3], [4]). The polymer electrolyte included in the composition of a composite electrode, for example for a lithium battery, must ensure both the mechanical cohesion of the electrode and the distribution of ions at any point of the electrode.

The present invention is precisely directed toward proposing a novel composite electrode, for example for a lithium battery, incorporating a solid electrolyte based on one or more aliphatic polycarbonates, in particular of the poly(trimethylene carbonate) type or copolymers thereof with ε-caprolactone, obtained under specific ring-opening (ROP) (co)polymerization synthetic conditions, catalyzed with methanesulfonic acid (MSA) or, alternatively, without catalyst, under microwave irradiation.

Aliphatic polycarbonates, in particular poly(trimethylene carbonate) (PTMC) and copolymers thereof, have already been described for forming polymeric solid electrolyte films or membranes, for example in rechargeable lithium batteries. Most of the polycarbonates proposed for forming solid electrolyte separators in rechargeable batteries, notably in lithium batteries, are obtained by Sn(Oct)₂-catalyzed ring-opening polymerization, as described, for example, by Brandell et al. ([5]) and Mindemark et al. ([6]).

More precisely, Brandell et al. ([5]) describe the synthesis of high molecular mass (368 000 g·mol⁻¹) poly(trimethylene carbonate) by ring-opening bulk polymerization catalyzed with stannous octanoate (Sn(Oct)₂) to form solid polymer electrolytes in lithium batteries. Using the same synthetic route, Mindemark et al. [6] describe the synthesis of random copolymers of trimethylene carbonate (TMC) and ε-caprolactone (CL), with molecular masses ranging from 457 000 to 508 000 g·mol⁻¹, for use as a solid polymer electrolyte.

However, the Sn(Oct)₂-catalyzed ring-opening polymerization synthetic route, as proposed by Brandell et al. and Mindemark et al., requires long reaction times (at least 72 hours) at high temperatures (≥130° C.), which does not allow their scaling up to industrial scale, due to excessive energy consumption. Moreover, the severe conditions of high-temperature synthesis do not allow control of the polymerization and polydispersity of the polycarbonates obtained. They are also liable to induce defects in the chemical structure of the polymers obtained. Finally, the catalyst used, Sn(Oct)₂, cannot be completely removed from the final product due to its solubility similar to that of the synthesized polymer in many organic solvents. For many applications of these polymers, for example as biomaterials, the residual presence of the catalyst in the polymeric material formed is not a problem. However, for applications related to electrochemical processes, such as in rechargeable lithium batteries, the presence of catalyst, and in particular of metal cations such as Sn²⁺, Zn²⁺, etc., is liable to have adverse effects on the performance and durability of the batteries, since these cations can also be reduced/oxidized during the charging/discharging processes.

To the inventors' knowledge, it has, moreover, never been proposed to incorporate polycarbonates obtained in this way by Sn(Oct)₂-catalyzed ROP into the composition of a composite electrode for an electrochemical system.

On the other hand, syntheses of aliphatic polycarbonates by ROP catalyzed with methanesulfonic acid (also known as methylsulfonic acid and abbreviated as “MSA”) or even without catalyst, under microwave irradiation, have been described.

Thus, Delcroix et al. [7] present a comparison of the use of methanesulfonic acid and trifluoromethanesulfonic acid (HOTf) to perform the ring-opening polymerization of trimethylene carbonate, using water or n-pentanol as polymerization initiator.

Microwave irradiation has also been proposed to conduct various polymerization reactions such as polycondensation, controlled radical polymerization and ring opening polymerization reactions. Liao et al. [8] thus describe the synthesis of poly(trimethylene carbonate) by microwave-assisted ring-opening polymerization in the presence of ethylene glycol as a reaction initiator. Microwave irradiation at a power of 10 W for a duration of 18 minutes thus makes it possible to obtain a PTMC with an average molecular mass Mn of 15 200 g·mol⁻¹, with a degree of conversion of 92%. The use of a higher irradiation time and power leads to a higher degree of conversion (95-96%), but the molecular mass Mn of the polymers obtained is then reduced, due to thermal degradation. In fact, the microwave-assisted reactions proposed by Liao et al. are conducted without control of the reaction temperature. Thus, at an irradiation power of 10 W, a maximum temperature of 154° C. is reached after 17 minutes and then decreases to reach a plateau after 24 minutes of irradiation. At higher irradiation powers, i.e. 20 W and 30 W, an exothermic peak of 168 and 173° C. is reached at 8 and 9 minutes, respectively. Thus, microwave-assisted polymerization under the conditions described in said publication does not make it possible to control the molecular mass of the PTMCs obtained, since the molecular masses Mn of the polycarbonates obtained are very different and are independent of the theoretical molecular masses calculated on the basis of the mole ratio between the monomers and the initiator.

Mention may also be made of the publication by Liao et al. [9], which describes the synthesis of poly(trimethylene carbonate)-b-poly(ethylene glycol)-b-poly(trimethylene glycol) (PTMC-PEG-PTMG) triblock copolymers by microwave-assisted ring-opening copolymerization in the absence of a catalyst. In the presence of PEG600, a copolymer with an average molecular mass Mn of 16 600 g·mol⁻¹ was obtained after microwave irradiation at 120° C. for 60 minutes.

However, these studies only relate to the synthesis of polymeric materials for applications as biomaterials, for example in the biomedical field, on account of the biocompatibility of these polymers and of the absence of metallic or toxic catalysts.

To the inventors' knowledge, it has never been proposed to take advantage of aliphatic polycarbonates and copolymers thereof, in particular obtained under specific ROP synthetic conditions, using MSA as catalyst or under microwave irradiation, for their use in an electrochemical system, for example for a rechargeable lithium battery, and all the less so for their incorporation into a composite electrode.

### SUMMARY OF THE INVENTION

The invention thus relates, according to a first of its aspects, to a composite electrode comprising, or even being formed from:
at least one solid electrolyte consisting of
one or more (co)polymers obtained by ring-opening (co)polymerization (ROP) of at least one five- to eight-membered cyclic carbonate and, optionally, of at least one five- to eight-membered lactone;
   said (co)polymerization reaction being catalyzed with methanesulfonic acid or performed under microwave irradiation in the absence of a catalyst;
   the hydroxyl functions at the end of the chain of said (co)polymer(s) being optionally protected; and
at least one alkali metal or alkaline-earth metal salt, in particular a lithium salt;
at least one electrode active material; and
optionally, one or more electrically conductive additives and/or one or more additional binders.

In the text hereinbelow, the term “aliphatic polycarbonate” or “polycarbonate” will be used more simply to denote a (co)polymer obtained by (co)polymerization by ROP according to the invention of at least one five- to eight-membered cyclic carbonate and, optionally, of at least one five- to eight-membered lactone.

Advantageously, said (co)polymer(s) are poly(trimethylene carbonate) (referred to hereinbelow as PTMC) or poly(trimethylene carbonate)-poly(ε-caprolactone) copolymers (referred to hereinbelow as PTMC-PCL), obtained by ring-opening polymerization of trimethylene carbonate (TMC), optionally by copolymerization with ε-caprolactone (CL). Advantageously, the polycarbonates obtained from a synthesis performed under the conditions of either of the abovementioned variants, using MSA as catalyst or under microwave irradiation in the absence of catalyst, in particular of the PTMC and PTMC-PCL type, have a controlled chemical structure. As confirmed by ¹H NMR analysis, the polycarbonates synthesized according to the invention thus advantageously have few, if any, defects in their chemical structure.

In addition, the synthesis performed under the conditions according to the invention advantageously affords access to polycarbonates with high purity.

In fact, when MSA is used as a catalyst, notably unlike stannous octanoate (Sn(Oct)₂), the MSA can be readily removed from the reaction medium, notably on account of its very high solubility in methanol, which is the solvent most commonly used for precipitating the synthesized polycarbonates.

In the second variant, the synthesis of the polycarbonates according to the invention even dispenses with the presence of a catalyst.

Thus, advantageously, the purity of the polycarbonates used according to the invention is greater than or equal to 90%, in particular greater than or equal to 95%, or even greater than or equal to 98%, or even greater than or equal to 99%. The purity can be verified by ¹H NMR analysis of the product obtained.

Preferably, the polycarbonates used according to the invention are obtained by ROP synthesis according to the invention, performed in the presence of a compound, in particular an organic molecule, called an “initiator” (or “primer”), bearing one or more hydroxyl functions, added to the initial reaction medium, in particular chosen from alcohols, notably alcohols bearing one to four hydroxyl functions. It affords access to polycarbonates of controlled mass and polydispersity.

In particular, the polycarbonates synthesized according to the invention can have a number-average molecular mass, Mn, of less than or equal to 200 000 g·mol⁻¹, in particular between 5000 and 100 000 g·mol⁻¹ and more particularly between 5000 and 50 000 g·mol⁻¹.

According to a particularly advantageous embodiment, the polycarbonates used according to the invention have protected chain-end hydroxyl functions. The protection of the hydroxyl functions of the polycarbonates according to the invention can be performed more particularly by reaction of said hydroxyl function(s) at the end of the polycarbonate chain with at least one compound, known as a protective agent, chosen from acyl chlorides, acid anhydrides and isocyanates. It can be performed by adding said protective agent(s) directly to the reaction medium obtained on conclusion of the (co)polymerization, or subsequently to a step of purification of said (co)polymer(s) (the “post-modification” route).

Moreover, the synthesis of the polycarbonates can be performed at room temperature and is thus particularly advantageous in terms of energy consumption. Also, the polycarbonates can be obtained advantageously for short polymerization times, in particular for a polymerization time of less than 3 days, in particular less than or equal to 72 hours, notably less than or equal to 48 hours. The polycarbonates used according to the invention can thus be obtained by a process that can be readily scaled up to large-scale production.

A composite electrode according to the invention can be prepared directly on the surface of a current collector from a dispersion, known as an “ink”, comprising the various components of the composite electrode dispersed in a solvent medium.

The invention thus relates to an ink for making a composite electrode, in particular as defined previously, comprising, in one or more solvents, in particular chosen from water and organic solvents:
one or more (co)polymers according to the invention, obtained by ring-opening (co)polymerization (ROP) of at least one five- to eight-membered cyclic carbonate and, optionally, of at least one five- to eight-membered lactone,
   said (co)polymerization reaction being catalyzed with methanesulfonic acid or performed under microwave irradiation in the absence of a catalyst;
   the hydroxyl functions at the end of the chain of said (co)polymer(s) being optionally protected;
at least one alkali metal or alkaline-earth metal salt, in particular a lithium salt.
at least one electrode active material, and optionally at least one electrically conductive additive and/or at least one additional binder.

The invention also relates to a process for preparing a composite electrode, in particular as defined previously, comprising at least the following steps:
preparation of a dispersion, known as an ink, as defined previously, comprising, in one or more solvents:
one or more (co)polymers obtained by ring-opening (co)polymerization (ROP) of at least one five- to eight-membered cyclic carbonate and, optionally, of at least one five- to eight-membered lactone;
   said (co)polymerization reaction being catalyzed with methanesulfonic acid or performed under microwave irradiation in the absence of a catalyst;
   the hydroxyl functions at the end of the chain of said (co)polymer(s) being optionally protected;
at least one alkali metal or alkaline-earth metal salt, in particular a lithium salt.
one or more electrode active materials and, optionally, one or more electrically conductive additives and/or one or more additional binders; and
forming from said ink, on the surface of a current collector, said composite electrode.

The composite electrode can be used for various electrochemical systems. Thus, the invention also relates to the use of a composite electrode according to the invention, in an electrochemical system, in particular in a lithium battery.

It also relates to an electrochemical system including a composite electrode according to the invention, a second electrode which may or may not be a composite electrode according to the invention, and an electrolyte, in particular acting as a separator, located between said composite electrode and said second electrode.

The electrochemical system may be a rechargeable battery, in particular a lithium battery, notably a lithium-ion or lithium-metal battery.

In a particular embodiment, the electrolyte between said composite electrode and said second electrode of the electrochemical device according to the invention consists of a solid electrolyte film, in particular of the solid polymer electrolyte or hybrid solid electrolyte type, of the same nature as that incorporated into the composite electrode, in other words based on one or more polycarbonates according to the invention, as used in said composite electrode.

The use of the solid electrolyte in the composition of the electrode according to the invention advantageously makes it possible to optimize the solid electrolyte/electrode interface of the electrochemical system.

The invention also relates to an electrode/electrolyte membrane assembly, in which said electrode is a composite electrode according to the invention, said electrolyte membrane more particularly being a solid electrolyte film, notably of the solid polymer electrolyte or hybrid solid electrolyte type, preferably based on one or more polycarbonates as used in said composite electrode.

The invention also relates to a process for preparing an electrochemical system according to the invention, in which a solid electrolyte film, preferably based on polycarbonates as described previously, is formed on the surface of a composite electrode according to the invention. The solid electrolyte film used as a separating electrolyte in an electrochemical system according to the invention may notably be of the solid polymer electrolyte (SPE) or hybrid solid electrolyte (HSE) type, as described more precisely in the text hereinbelow. Advantageously, the use of a solid electrolyte based on one or more polycarbonates according to the invention affords access to a composite electrode with excellent electrochemical performance in the electrochemical system.

The solid electrolyte based on polycarbonates according to the invention advantageously provides a high level of conductivity.

In particular, the inventors have shown that the use of aliphatic polycarbonates, in particular of the PTMC and PTMC-PCL type, obtained by synthesis by ring-opening (co)polymerization under the conditions of the invention, makes it possible, in combination with at least one alkali metal or alkaline-earth metal salt, in particular a lithium salt, to produce solid electrolytes with improved performance, in particular in terms of improved ion conductivity and electrochemical stability, compared to electrolytes prepared from polycarbonates obtained via other synthetic routes, such as by Sn(Oct)₂-catalyzed ROP.

As illustrated in the examples that follow, the solid electrolytes obtained from the polycarbonates, in particular of the PTMC or PTMC-PCL type, synthesized according to the invention, thus have excellent performance, in particular high ion conductivity, for example greater than or equal to 10⁻⁶ S·cm⁻¹ at 60° C., in particular greater than or equal to 10⁻⁶ S·cm⁻¹ for a PTMC and greater than or equal to 10⁻⁵ S·cm⁻¹ for a PTMC-PCL at 60° C.; and a lithium ion transport number, noted t₊, of greater than or equal to 0.50 at 60° C., in particular greater than or equal to 0.70 for PTMC and greater than or equal to 0.60 for PTMC-PCL at 60° C.

The solid electrolytes based on polycarbonates synthesized according to the invention also have improved electrochemical stability.

In particular, they have a wide electrochemical stability window, in particular up to 4.50 V versus Li/Li⁺. Thus, a composite electrode incorporating a solid electrolyte according to the invention is particularly useful for batteries of high energy density, i.e. batteries operating at a potential difference of greater than 4 V versus Li/Li⁺, in particular greater than or equal to 4.2 V versus Li/Li⁺, such as Li⁰ vs. LiNi_{0.6}Mn_{0.2}Co_{0.2}O₂ batteries.

A composite electrode according to the invention can also be used for electrochemical systems, in particular lithium batteries, operating over a wide temperature range, preferably between −20° C. and 90° C., in particular between −10° C. and 80° C.

The solid electrolyte used according to the invention thus ensures the maintenance of electrical, i.e. ionic and electronic, contacts within the composite electrode, thus enabling good performance of the electrochemical device in terms of power and cycling capacity. Moreover, the solid electrolyte advantageously has good flexibility and is not very brittle. The solid electrolyte acts as a deformable binder within the composite electrode. Advantageously, it is capable of accommodating the volume variations of the electrode active materials that occur during discharging/charging cycles, without having an impact on the electrochemical performance.

The solid electrolyte gives the composite electrode good properties in terms of ion conductivity, flexibility and adhesion to the current collector.

Other features, variants and advantages of a composite electrode according to the invention, of its preparation and of its use in an electrochemical system, will emerge more clearly from the description, examples and figures which follow, which are given as nonlimiting illustrations of the invention.

### BRIEF DESCRIPTION OF THE DRAWINGS

FIG. 1 shows the ¹H NMR spectra of the 3-phenyl-1-propanol (PPA)-initiated PTMC polymers with an average molecular mass Mn of about 10 000 g·mol⁻¹ synthesized in Example 1, using (a) the catalyst MSA (P10PPA), (b) microwave irradiation in the presence of toluene (MW10PPA-T) and (c) using the catalyst Sn(Oct)₂ (S10PPA);

FIG. 2 shows the ¹H NMR spectra of the “protected” PTMC polymers with an average molecular mass Mn of about 10 000 g·mol⁻¹, synthesized in Example 1, using the protecting agent benzoyl chloride (BC) (a), and p-toluenesulfonyl isocyanate (TSI) (b);

FIG. 3 shows the ¹H NMR spectra of the PTMC60-PCL40 copolymers (10 000 g·mol⁻¹), synthesized in Example 2, initiated with PPA using (a) the catalyst MSA (G10PPA), (b) microwave irradiation in the presence of toluene (M10PPA-T) and (c) using the catalyst Sn(Oct)₂ (R10PPA);

FIG. 4 shows the H NMR spectra of the PTMC60-PCL40 copolymers (10 000 g·mol⁻¹), synthesized in Example 2 using the catalyst MSA and the initiator PPA, “protected” with benzoyl chloride (BC) (a), and p-toluenesulfonyl isocyanate (TSI) (b);

FIG. 5 shows the curves of ion conductivity versus temperature obtained for the solid polymer electrolytes based on PTMC, synthesized in Example 1, using the catalyst MSA (P10PPA-TFSI15) and Sn(Oct)₂ (S10PPA-TFSI15), and using microwave irradiation in the presence of toluene (MW10PPA-T-TFSI15), prepared in Example 3;

FIG. 6 shows the curves of ion conductivity versus temperature obtained for the P10PPA-based solid polymer electrolytes containing different concentrations of LiTFSI salt, prepared in Example 3;

FIG. 7 shows the curves of ion conductivity versus temperature obtained for the P10PPA-based solid polymer electrolytes containing different concentrations of LiFSI salt, prepared in Example 3;

FIG. 8 shows the curves of ion conductivity versus temperature obtained for the solid polymer electrolytes based on PTMC60-PCL40 copolymer, synthesized in Example 2, using the catalyst MSA (G10PPA-TFSI15) and Sn(Oct)₂ (R10PPA-TFSI15), and using microwave irradiation in the presence of toluene (M10PPA-T-TFSI15), prepared in Example 3;

FIG. 9 shows the cyclic voltammetry curves obtained for the solid electrolytes P10PPA-TFSI15, MW10PPA-T-TFSI15 and S10PPA-TFSI15 based on the unprotected PTMCs synthesized in Example 1 using the initiator PPA, as described in Example 3;

FIG. 10 shows the cyclic voltammetry curves of the solid electrolytes based on the unprotected PTMC (P10PPA-TFSI15), and protected PTMC (P10PPA-BC-TFSI15 and P10PPA-TSI-TFSI15), synthesized in Example 1, using the catalyst MSA and the initiator PPA, as described in Example 3;

FIG. 11 shows the cyclic voltammetry curves obtained for the solid electrolytes G10PPA-TFSI15, M10PPA-T-TFSI15 and R10PPA-TFSI15 based on the unprotected PTMC-PCL copolymers synthesized in Example 2, using the initiator PPA as described in Example 3;

FIG. 12 shows the cyclic voltammetry curves of the solid electrolytes based on the unprotected PTMC-PCL copolymer (G10PPA-TFSI15) and the protected PTMC-PCL copolymers (P10PPA-BC-TFSI15 and P10PPA-TSI-TFSI15), synthesized in Example 2, using the catalyst MSA and the initiator PPA, as described in Example 3;

FIG. 13 shows the galvanostatic cycling curves of a complete battery containing the protected PTMC-based solid polymer electrolyte (SPE) (P10PPA-BC-TFSI15), as described in Example 3, and the protected PTMC-based composite cathode (NMC2P10PPA-BC), as described in Example 4;

FIG. 14 shows the galvanostatic cycling curves of a complete battery containing the protected PTMC-based hybrid solid electrolyte (HSE) (P10PPA-BC-TFSI15-LATP20), as described in Example 3, and the protected PTMC-based composite cathode (NMC2P10PPA-BC), as described in Example 4;

FIG. 15 shows the galvanostatic cycling curves of a complete battery containing the hybrid solid electrolyte (HSE) based on the protected PTMC-PCL copolymer (G10PPA-BC-TFSI15-LATP20), as described in Example 3, and the composite cathode based on the protected PTMC (NMC2P10PPA-BC), as described in Example 4;

FIG. 16 shows the galvanostatic cycling curves of a complete battery containing the hybrid solid electrolyte (HSE) based on the protected PTMC-PCL copolymer (G10PPA-BC-TFSI2-LATP20), as described in Example 3, and the composite cathode based on the protected PTMC (NMC2P10PPA-BC), as described in Example 4.

In the text hereinbelow, the terms “between . . . and . . . ”, “ranging from . . . to . . . ” and “varying from . . . to . . . ” are equivalent and are intended to mean that the limits are included, unless otherwise mentioned.

### DETAILED DESCRIPTION

### Polycarbonate (Co)Polymer

As indicated previously, a composite electrode according to the invention incorporates a solid electrolyte based on one or more (co)polymers obtained by ring-opening (co)polymerization (ROP) of at least one five- to eight-membered cyclic carbonate and, optionally, of at least one five- to eight-membered lactone, made conductive by dissolving at least one alkali metal or alkaline-earth metal salt, in particular a lithium salt.

The term “copolymer” means a polymer derived from at least two different monomer species. In the text hereinbelow, unless otherwise indicated, the term “polymer” or “polycarbonate” will be used to refer, in a broad sense, to both homopolymers and copolymers.

The cyclic carbonate monomers may more particularly be of formula (I) below:

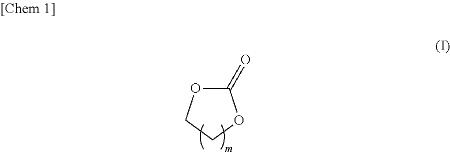

in which m is an integer between 1 and 4, notably between 1 and 3, in particular m is 1 or 2 and more particularly m is 2;

said monomers being optionally substituted, on one or more of the carbon atoms of the ring, with one or more substituents, in particular chosen from linear or branched alkyl groups, in particular of C₁ to C₅.

Thus, the cyclic carbonate monomers may be of formula (I′) below

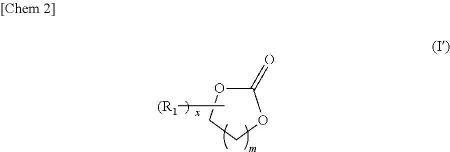

in which m is as defined previously; x is an integer between 0 and 2m+2; and R₁, borne by one or more carbon atoms of the ring, represent, independently of each other, substituents, in particular linear or branched C₁ to C₅ alkyl groups.

According to a particular embodiment, the cyclic carbonate monomer is chosen from trimethylene carbonate and derivatives thereof. In particular, the cyclic carbonate monomer is trimethylene carbonate.

According to a first implementation variant, the polycarbonate synthesized according to the invention is a (co)polymer obtained by ROP of one or more cyclic carbonate monomers.

In particular, it may be a poly(trimethylene carbonate), denoted PTMC, obtained by ROP of trimethylene carbonate (TMC).

According to another implementation variant, the polymer synthesized according to the invention is a copolymer obtained by ROP of at least one cyclic carbonate monomer, in particular as defined previously, and of at least one lactone-type monomer.

Preferably, the mole ratio between the cyclic carbonate monomer(s) and the lactone-type monomer(s) is between 90/10 and 10/90, notably between 80/20 and 20/80, in particular between 70/30 and 30/70 and more particularly about 60/40.

The term “lactone” more particularly means monomers corresponding to the following formula (II):

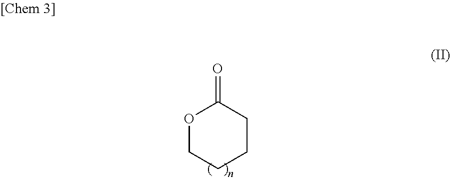

in which n is 0 or an integer ranging from 1 to 3;

said monomers being optionally substituted, on one or more of the carbon atoms of the ring, with one or more substituents, in particular chosen from linear or branched alkyl groups, in particular of C₁ to C₅.

Thus, the lactone-type monomers may be of the following formula (II′):

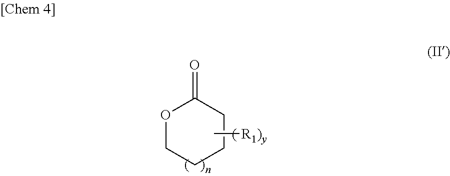

in which n is as defined previously; y is an integer between 0 and 2n+6; and R₁, borne by one or more carbon atoms of the ring, represent, independently of each other, substituents, in particular linear or branched C₁ to C₅ alkyl groups.

According to a particular embodiment, the copolymer according to the invention is formed from ε-caprolactone (denoted CL).

More particularly, the copolymers may be of the random or gradient type.

By way of example, the copolymer according to the invention may be formed from trimethylene carbonate (TMC) and ε-caprolactone (CL). In other words, it may be a poly(trimethylene carbonate)-poly(ε-caprolactone) copolymer (PTMC-PCL), in particular with a mole ratio between the monomer units derived from TMC and the monomer units derived from CL of between 90/10 and 10/90, notably between 80/20 and 20/80, in particular between 70/30 and 30/70, and more particularly about 60/40.

According to a particular embodiment, the (co)polymers used according to the invention are chosen from PTMC, PTMC-PCL copolymers, in particular as described previously, and mixtures thereof.

### Preparation of the Polycarbonates

As indicated previously, the polycarbonates used according to the invention to form the solid electrolyte incorporated into a composite electrode according to the invention are prepared by ring-opening (co)polymerization of the monomers as described previously. Advantageously, the ROP is performed either in the presence of methanesulfonic acid (referred to hereinbelow as MSA) as a catalyst, or in the absence of a catalyst, under microwave irradiation.

More particularly, according to a first implementation variant, the polycarbonates incorporated into a composite electrode according to the invention are obtained by ring-opening (co)polymerization (ROP) catalyzed with methanesulfonic acid (MSA) and initiated, or not, with at least one compound including one or more hydroxyl function(s)

In the case of a synthesis catalyzed with MSA, said monomer(s) and said MSA catalyst may more particularly be used in a monomer(s)/MSA mole ratio of between 40/1 and 1000/1, in particular between 50/1 and 500/1.

According to a particular embodiment, the polycarbonates used to form a solid electrolyte incorporated into a composite electrode according to the invention may be prepared more particularly via at least the following steps:

(a1) synthesis, in the presence or absence of a solvent medium, of at least one (co)polymer by ring-opening (co)polymerization (ROP) of at least one five- to eight-membered cyclic carbonate and, optionally, of at least one five- to eight-membered lactone, said (co)polymerization reaction being catalyzed with methanesulfonic acid (MSA) and initiated, or not, with at least one compound including one or more hydroxyl function(s), in particular with one or more alcohols as described in the text hereinbelow;
(a2) optionally, protection of the hydroxyl functions at the end of the chain of said (co)polymer(s); and
(a3) purification, prior to or subsequent to step (a2) of protecting the hydroxyl functions, of said (co)polymer(s), in particular by precipitation from one or more polar solvents.

According to another implementation variant, the polycarbonates incorporated into a composite electrode according to the invention are obtained by ring-opening (co)polymerization (ROP) in the absence of a catalyst, under microwave irradiation and initiated with at least one compound including one or more hydroxyl function(s).

In particular, the polycarbonates used to form a solid electrolyte incorporated into a composite electrode according to the invention can be prepared via at least the following steps:

(b1) synthesis of at least one (co)polymer by ring-opening (co)polymerization (ROP) of at least one five- to eight-membered cyclic carbonate and, optionally, of at least one five- to eight-membered lactone, said (co)polymerization reaction being performed in the absence of a catalyst, under microwave irradiation and initiated with at least one compound including one or more hydroxyl functions;
optionally (b2) protection of the hydroxyl functions at the end of the chain of said (co)polymer(s)
and optionally (b3) purification, prior to or subsequent to step (b2) of protecting the hydroxyl functions, of said (co)polymer(s), in particular by precipitation from one or more polar solvents.

As indicated previously, the polycarbonates are obtained, preferably, by ROP conducted in the presence of a compound, in particular of an organic molecule, including one or more hydroxyl functions, known as the “initiator” (or “primer”).

The ROP initiator compound may be of various kinds, provided that it contains at least one hydroxyl function for initiating the polymerization reaction. It may be chosen in particular from water and/or alcohols, in particular alcohols containing one to four hydroxyl functions.

According to a particular embodiment, the ROP initiator may be water. This may be, for example, the residual water provided with at least one of the cyclic carbonate and/or lactone monomers used.

According to a particularly advantageous embodiment, the initiator is provided in a specific amount in the initial reaction mixture.

Said ROP initiator may have a number-average molecular mass ranging from 90 to 1000 g·mol⁻¹, in particular from 90 to 500 g·mol⁻¹.

It may be chosen more particularly from alcohols containing one or more hydroxyl functions, in particular one to four hydroxyl functions, notably one or two hydroxyl functions.

According to a particular embodiment, the initiator is a monoalcohol. More particularly, it may be a compound ROH in which the group R represents an “unreactive” group.

The term “unreactive” group denotes a group which is unreactive under the conditions of preparation and use of the polycarbonate according to the invention. More particularly, the group R does not bear a function which is reactive with respect to the cyclic carbonate and lactone monomers used, nor a function which is reactive with respect to alkali metals or alkaline-earth metals, notably with respect to lithium metal, or alkali metal or alkaline-earth metal salts, notably with respect to lithium salts.

The group R may more particularly be:
a linear or branched alkyl group, which may be substituted with fused or nonfused, saturated or unsaturated, aromatic or nonaromatic monocyclic or polycyclic or monoheterocyclic or polyheterocyclic groups; or
a fused or nonfused, saturated or unsaturated, aromatic or nonaromatic monocyclic or polycyclic or monoheterocyclic or polyheterocyclic group;
   the alkyl group and/or said mono(hetero)cyclic or poly(hetero)cyclic group(s) may optionally be substituted with one or more fluorine atoms.

In the context of the invention, the following definitions apply:
“alkyl”: a linear or branched, saturated aliphatic group; for example, a C₁₋₄ alkyl group represents a linear or branched carbon-based chain of 1 to 4 carbon atoms, more particularly a methyl, ethyl, propyl, isopropyl, butyl, isobutyl or tert-butyl;
“polycyclic group”: a group containing two or more nuclei (rings), which are fused (ortho-fused or ortho- and peri-fused) together, i.e. having, in pairs, at least two carbons in common;
“heterocycle”: a cyclic group, which is preferably 4-, 5- or 6-membered, comprising one or more heteroatoms, in particular chosen from oxygen, sulfur and nitrogen. The mono- or poly(hetero)cyclic groups according to the invention may be unsaturated, partially saturated or saturated. An aromatic ring may notably be benzene.

In particular, a polycyclic group according to the invention is formed from 2 to 6 rings, the rings comprising, independently of each other, from 4 to 6 ring members. The polycyclic group may include one or more heteroatoms. This is then referred to as a “polyheterocyclic group”.

The initiator used for the synthesis of the polycarbonates by ROP according to the invention may be chosen, for example, from the following molecules.

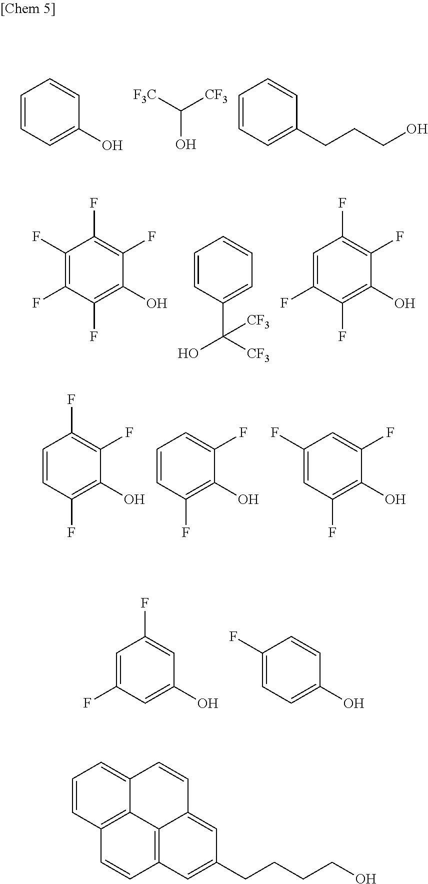

According to another particular embodiment, the initiator is a compound containing at least two hydroxyl functions, in particular from two to four hydroxyl functions, for example two hydroxyl functions.

In particular, it may be a compound of formula R′(—OH)ₓ, in which x represents an integer ranging from 2 to 4; and R′ represents a divalent, trivalent or tetravalent unreactive group, in particular a linear or branched C₁ to C₆, notably C₁ to C₃, alkylene group, such as ethylene glycol (also denoted as “EG”) or glycerol.

The initiator may also be a macroinitiator. For the purposes of the invention, the term “macroinitiator” means a polymer including, at at least one of its ends, a hydroxyl function capable of initiating the ROP reaction according to the invention. It makes it possible to lead to the formation of a block copolymer. Said macroinitiator may be, for example, a polydimethylsiloxane, bearing a hydroxyl end function.

The nature of the initiator used to initiate the ROP reaction for the synthesis of the polycarbonates according to the invention is by no means limited to the abovementioned compounds, and other initiators may be envisaged.

Advantageously, in the case of an initiator bearing several hydroxyl functions, the pKa values of the different hydroxyl functions are substantially identical. This affords access to polycarbonates with a branched structure, or dendrimers, with symmetrical branches. According to a particular embodiment, the initiator is chosen from 3-phenyl-1-propanol (also denoted as “PPA”) and ethylene glycol.

In the case of the use of an initiator, said initiator will be incorporated at the end of the chain of the synthesized (co)polymer.

The use of an ROP initiator, in particular provided in a specific amount, in the initial reaction mixture advantageously makes it possible to control the molar mass and the polydispersity of the polycarbonates synthesized according to the invention.

According to a particular embodiment, said monomer(s) and said initiator(s) are used in a monomer/initiator mole ratio of between 40/1 and 1000/1, in particular between 50/1 and 500/1.

According to a particular embodiment, in the case of MSA-catalyzed ROP synthesis, the initiator(s)/MSA catalyst mole ratio is between 1/1 and 10/1, and in particular is about 1/1.

According to yet another implementation variant, in the case of the MSA-catalyzed synthesis of the (co)polymer by ROP, this can be performed in the absence of an initiator, in particular in the absence of water and of an alcohol compound.

In this case, the ring-opening polymerization of the monomers can be initiated with one of the cyclic carbonate monomers, e.g. trimethylene carbonate, activated according to an “active chain-end” mechanism (ACEM).

As mentioned previously, the ROP reaction, according to either of the abovementioned variants, is advantageously performed at low temperature, in particular at a temperature of less than or equal to 200° C., in particular less than or equal to 160° C. and more particularly less than or equal to 140° C.

The polymerization time can be adjusted to obtain a high conversion of the monomers. In particular, the polymerization time is advantageously short; it may be less than or equal to 72 hours, in particular less than or equal to 48 hours.

In particular, in the case of an MSA-catalyzed ROP synthesis, the ROP reaction can advantageously be performed at a temperature less than or equal to 40° C., notably between 20 and 40° C. and more particularly at room temperature. The term “room temperature” means a temperature of 25±5° C.

The polymerization time may be less than or equal to 72 hours, in particular less than or equal to 48 hours and more particularly between 24 and 48 hours.

In the case of microwave-assisted ROP synthesis, the ROP (co)polymerization can be performed by subjecting the reaction medium to microwave irradiation. The microwave irradiation may include permitted wavelengths of either 915 MHz or 2.45 GHz, in particular 2.45 GHz.

The microwave irradiation may be performed using a microwave oven, for instance a CEM Mars microwave oven, or a microwave generator.

The microwave irradiation is advantageously performed by controlling the temperature of the reaction medium. In particular, the temperature can be maintained at a value, preferably a constant value, of between 100 and 200° C., more particularly between 120° C. and 160° C. and notably between 120° C. and 140° C. The desired temperature can be reached by imposing a temperature rise at a rate of the order of 10° C./minute to 50° C./minute. Advantageously, the power used during this irradiation does not exceed 300 W, and in particular is between 30 and 300 W and more particularly between 40 and 100 W.

The microwave irradiation can be conducted for a very short time, in particular between 30 minutes and 300 minutes, in particular between 60 and 180 minutes and more particularly between 60 and 120 minutes.

According to a particular embodiment, the microwave-assisted (co)polymerization by ROP is performed by subjecting the reaction mixture comprising said monomer(s) as described previously and said initiator(s), in particular having a monomer(s)/initiator(s) mole ratio of between 40/1 and 1000/1, to microwave irradiation at a power of less than or equal to 300 W, in particular between 30 and 300 W, notably between 40 and 100 W, for an irradiation time of between 30 and 300 minutes, notably between 60 and 180 minutes, in particular between 60 and 120 minutes and more particularly about 60 minutes, and at a controlled temperature of between 100° C. and 200° C., notably between 120° C. and 160° C., in particular between 120° C. and 140° C.

The degree of conversion into monomers after the synthesis of the polycarbonate according to either of the abovementioned variants is advantageously greater than 90%, in particular greater than 95%. The degree of conversion or conversion yield can be determined from the mass of the (co)polymers obtained and the masses of starting monomer(s) and, optionally, of starting initiator.

The ROP reaction can be performed in bulk (in the absence of solvent) or in solvent medium.

In the case of an MSA-catalyzed ROP synthesis, the reaction can advantageously be performed in a solvent medium, in particular with stirring. The solvent medium may more particularly be formed from one or more apolar aprotic solvents. Said apolar aprotic solvent(s) may be chosen more particularly from toluene, dichloromethane, tetrahydrofuran, dimethyl sulfoxide, dimethylacetamide and mixtures thereof. In particular, the MSA-catalyzed ROP synthesis can be performed in dichloromethane.

According to a particular embodiment, the concentration of monomers in the initial reaction medium is greater than or equal to 3 mol·L⁻¹ (M), in particular greater than or equal to 5 mol·L⁻¹. It may be between 3 and 15 mol·L⁻¹, in particular between 5 and 10 mol·L⁻¹.

In the case of a microwave-assisted ROP synthesis, the reaction can advantageously be performed using a reaction mixture comprising a small amount of solvent or even being solvent-free (bulk polymerization).

Thus, the (co)polymerization reaction can be performed in the presence of one or more organic solvents, in particular used in a content of less than or equal to 0.3 mL/g of monomer(s), in particular less than or equal to 0.1 mL/g of monomer(s), or may even be solvent-free (bulk polymerization). Said solvent(s) may be more particularly chosen from apolar aprotic solvents as mentioned previously.

According to a particular embodiment, the starting reaction medium is formed from said monomer(s), said initiator(s), and optionally one or more solvents, in particular in a low content as indicated previously.

According to another particular embodiment, the (co)polymerization reaction is performed in the absence of solvent. The starting reaction medium may thus be formed solely from the mixture of said monomer(s) and said initiator(s), in the absence of solvent.

The ROP reaction for the synthesis of polycarbonates according to the invention may be performed in continuous, semi-continuous or batch mode.

According to a particular embodiment, it is performed in a batch manner, all the monomers being introduced into the reactor at once, the (co)polymer being recovered in one portion at the end of the reaction.

According to another embodiment, the ROP reaction can be performed in a semi-continuous or continuous manner, in particular in the case of the synthesis of random or gradient type copolymers. More particularly, it may comprise a phase of gradual introduction of said monomer(s) into the reactor. The gradual introduction of the monomers may be performed by adding successive fractions of monomer(s) during the polymerization, or continuously.

At the end of the (co)polymerization, possibly after protection of the hydroxyl functions at the end of the chains as described more precisely in the text hereinbelow, the polycarbonates may be subjected to one or more purification steps, for example by precipitation from one or more polar solvents, typically methanol or ethanol, and recovered by filtration and drying.

This is notably the case for the MSA-catalyzed ROP synthesis of polycarbonates for catalyst removal purposes. Advantageously, the MSA catalyst can be readily removed, in its entirety, from the reaction medium, giving polycarbonates in very high purity. Advantageously, the synthesis of polycarbonates by microwave-assisted ROP, without catalyst, makes it possible to dispense with the purification steps. The polycarbonates obtained on conclusion of the microwave-assisted ROP reaction, in particular performed in bulk, can be used directly for the preparation of an ink for the production of a composite electrode according to the invention, without an intermediate purification step.

The polycarbonates obtained according to the invention at the end of the ROP synthesis according to one or other of the abovementioned variants are advantageously of high purity. In particular, the purity of the polycarbonates obtained is advantageously greater than or equal to 90%, in particular greater than or equal to 95%, or even greater than or equal to 98% or even greater than or equal to 99%. The purity can be verified by H NMR analysis of the product obtained.

Moreover, the polycarbonates synthesized according to the invention advantageously have few or no defects in their chemical structure. The absence of structural defects can be confirmed by ¹H NMR analysis of the (co)polymers.

As illustrated in the examples, the ¹H NMR spectrum of a polycarbonate synthesized according to the invention thus shows a peak at 3.43 ppm, representative of ether bonds, of very low intensity, or even shows no identifiable peak at 3.43 ppm. On the other hand, in contrast to polycarbonates synthesized according to the invention, the spectrum of polycarbonates synthesized according to other synthetic routes, in particular with the aid of the Sn(Oct)₂ catalyst, shows a peak of higher intensity at 3.43 ppm, which is evidence of the presence of structural defects (ether bonds) in the structure of the polycarbonates, due to undesirable decarboxylation reactions.

Advantageously, the polycarbonates obtained according to the invention by ROP under the conditions of either of the variants described previously, advantageously in the presence of an initiator as described previously, added in a determined amount to the initial reaction medium, have a controlled molar mass and, preferably, a controlled polydispersity.

In particular, the polycarbonates synthesized according to the invention advantageously have a number-average molar mass, denoted Mn, of less than or equal to 200 000 g·mol⁻¹, in particular between 5000 and 100 000 g·mol⁻¹, and more particularly between 5000 and 50 000 g·mol⁻¹. The number-average molar mass can be measured by size exclusion chromatography (or SEC). It can also be obtained from the ¹H NMR analysis of the (co)polymer obtained.

It can advantageously be controlled according to the synthetic method used according to the invention by the mole ratio of said monomer(s) to the initiator in the initial reaction mixture.

The (co)polymers synthesized according to the invention may have a polydispersity index of less than or equal to 3.5, in particular less than or equal to 2.5.

The polydispersity index, denoted PDI, is equal to the ratio of the weight average molar mass Mw to the number average molar mass Mn. The weight-average molar mass can be determined by size exclusion chromatography, possibly coupled with static light scattering. According to a particular embodiment, the polycarbonates used according to the invention, in particular obtained by MSA-catalyzed ROP, may have a polydispersity index of less than or equal to 1.5, in particular less than or equal to 1.3.

The polycarbonates synthesized according to the invention of PTMC type may have a glass transition temperature, denoted Tg, of between −10° C. and −50° C., in particular between −20° C. and −40° C. Copolymers of the PTMC-PCL type may have a Tg of between −20° C. and −70° C., in particular between −30° C. and −60° C. The glass transition temperature can be determined by differential scanning calorimetry (DSC) analysis.

The polycarbonates obtained from the ROP synthesis conducted according to the invention, in the presence of an initiator of the R—OH monoalcohol type, may be, for example, of formula (III) below:

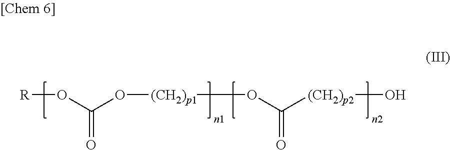

in which:

R represents the group derived from the monoalcohol initiator ROH, as defined previously, for example a phenylpropyl group derived from the initiator PPA;

p1 is an integer ranging from 2 to 4, in particular p1 is 3;

p2 is an integer ranging from 4 to 7, in particular p2 is 5;

n1 is a positive integer, corresponding to the average number of monomer units derived from the cyclic carbonate monomers, in particular n1 is between 30 and 500;

n2 is 0 or a positive integer, corresponding to the average number of monomer units derived from lactone monomers, in particular n2 is between 20 and 500;

the sequence of the monomer units in formula (III) possibly being random or gradient. Preferably, as described previously, the mole ratio of the monomer units derived from the cyclic carbonates to the monomer units derived from the lactones, n1/n2, is between 90/10 and 10/90, in particular between 80/20 and 20/80, notably between 70/30 and 30/70 and more particularly is about 60/40.

By way of example, the polycarbonates synthesized according to the invention may have the structure of formula (III′) below:

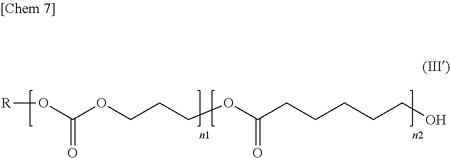

in which R, n1 and n2 are as defined previously.

Needless to say, more complex polymeric structures, for example of the dendrimer type, can be obtained from an initiator using several hydroxyl functions.

As mentioned previously, according to a particular embodiment, the hydroxyl function(s) at the end of the chains, also known as the “end functions”, of the polycarbonates used according to the invention are protected (or capped) prior to their use for forming a composite electrode according to the invention.

A polycarbonate synthesized according to the invention may comprise a single hydroxyl end function or two or even more than two hydroxyl end functions, notably depending on whether or not an initiator of the ROP reaction is used, and also on the nature of the initiator (for example, monoalcohol or diol).

The formation of capped hydroxyl ends (more generally denoted as “end-capped” hydroxyls) advantageously makes it possible to increase the electrochemical stability of the solid electrolyte formed from said polycarbonate(s), and thus of the composite electrode incorporating said solid electrolyte, the hydroxyl end functions being sensitive to reduction and to oxidation, and liable to degrade on contact with lithium salts.

A hydroxyl function is more particularly protected by forming a function that is more chemically and electrochemically stable. For example, said protected hydroxyl function(s) at the end of said polycarbonate chain may result from the reaction of said hydroxyl function(s) with at least one compound, known as a “protective agent”, in particular chosen from acyl chlorides, for example benzoyl chloride, acetyl chloride, etc.; acid anhydrides, for example acetic anhydride as described in publication [10], etc., and isocyanates, for example p-toluenesulfonyl isocyanate, etc.

The protection of the hydroxyl functions can be performed by directly adding said protective agent(s) to the reaction medium obtained from the (co)polymerization, prior to the purification of the polycarbonate in the case of MSA-catalyzed ROP synthesis. It can also be performed after purification of the polycarbonate obtained at the end of the ROP synthesis (variant known as “post-modification” of the polycarbonate).

A person skilled in the art is capable of adjusting the operating conditions to achieve protection of the hydroxyl end function(s) of the polycarbonates according to the invention. Examples of procedures for the protection of the hydroxyl functions using benzoyl chloride and p-toluenesulfonyl isocyanate are illustrated in the example section which follows.

### Preparation of the Composite Electrode

As mentioned previously, the polycarbonates synthesized according to the invention, after purification and possibly after protection of the hydroxyl functions at the end of the chain, are used to prepare a composite electrode.

A composite electrode according to the invention can be prepared more particularly from a dispersion, more commonly known as an “ink”, comprising, in one or more solvents:
at least one polycarbonate as described previously;
at least one alkali metal or alkaline-earth metal salt, in particular a lithium salt;
at least one electrode active material, and optionally at least one electrically conductive additive and/or at least one additional binder.

### Alkali-Metal or Alkaline-Earth Metal Salt

The solid polymer electrolyte incorporated into a composite electrode according to the invention includes at least one alkali metal or alkaline-earth metal salt to make it conductive.

In the context of the invention, the following definitions apply:
“alkali metals”: the chemical elements from the first column of the Periodic Table of the Elements, more particularly chosen from lithium, sodium, potassium, rubidium and cesium. Preferably, the alkali metal is lithium, sodium or potassium, and more preferentially lithium;
“alkaline-earth metals”: the chemical elements from the second column of the Periodic Table of the Elements, more particularly chosen from beryllium, magnesium, calcium, strontium, barium and radium. Preferably, the alkaline-earth metal is magnesium or calcium.

The alkali metal salt may be, for example, a lithium salt or a sodium salt; the alkaline-earth metal salt may be, for example, a magnesium salt. In particular, the salt used is a lithium salt.

Examples of lithium salts that may be mentioned are LiPF₆, LiClO₄, LiBF₄, LiAsF₆, LiCF₃SO₃, lithium bis(trifluoromethylsulfonyl)imide LiN[SO₂CF₃]₂ (known by the abbreviation LiTFSI), lithium bis(fluorosulfonyl)amide (known by the abbreviation LiFSI) LiN[SO₂F]₂, lithium 4,5-dicyano-2-(trifluoromethyl)imidazole (known by the abbreviation LiTDI), lithium bispentafluoroethylsulfonylimide (LiN(C₂F₅SO₂)₂, known by the abbreviation LiBETI), lithium bis(oxalato)borate (known by the abbreviation LiBOB), lithium difluoro(oxalato)borate (known by the abbreviation LiFOB), lithium difluorophosphate (LiPO₂F₂) and mixtures thereof.

Preferably, the lithium salt is LiTFSI, LiTDI or LiFSI, preferably LiTFSI or LiFSI and more preferentially LiTFSI.

It falls to a person skilled in the art to adjust the amount of alkali metal or alkaline-earth metal salts, notably with regard to the nature of the polycarbonate used.

According to a particular embodiment, the amounts of polycarbonate(s) and lithium salt(s) are adjusted so that the mole ratio between the carbonyl groups of the polycarbonate with respect to lithium, denoted [CO]/[Li⁺], is between 0.1 and 30, in particular between 5 and 15.

### Other Components of the Composite Electrode

The active materials for a positive composite electrode may be chosen, for example, from lithium intercalation materials such as lithium phosphates, for example compounds of the formula LiₓFe_{1-y}M_{y}PO₄ in which M is chosen from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6; compounds of the formula LiₓMn_{1-y-z}M′_{y}M″_{z}PO₄ (LMP) in which M′ and M″ are different from each other and are chosen from the group consisting of B, Mg, Al, Si, Ca, Ti, V, Cr, Fe, Co, Ni, Cu, Zn, Y, Zr, Nb, and Mo; with 0.8≤x≤1.2; 0≤y≤0.6 and 0≤z≤0.2; such as LiFePO₄ (LFP), LiMnPO₄, LiMn_{y}Fe_{1-y}PO₄ with 0.8≤x≤1.2; 0≤y≤0.6; lamellar compounds, such as lithiated cobalt oxide LiCoO₂, lithiated manganese oxide LiMn₂O₄, or materials based on lithium-nickel-cobalt-manganese LiNiₓMn_{y}Co_{z}O₂ with x+y+z=1 (also known as NMC), such as LiNi_{0.33}Mn_{0.33}Co_{0.33}O₂ or LiNi_{0.6}Mn_{0.2}Co_{0.2}O₂, or a material based on LiNiₓCo_{y}Al_{z}O₂ with x+y+z=1 (also known as NCA), or spinels (for example the spinel LiNi_{0.5}Mn_{1.5}O₄). Advantageously, the active materials for a positive electrode are chosen from LiNi_{0.6}Mn_{0.2}Co_{0.2}O₂(NCM cathodes) or LiCoO₂, preferably LiNi_{0.6}Mn_{0.2}Co_{0.2}O₂.

The active materials for a negative composite electrode may be, for example, carbon, graphite, lithiated titanium oxide (Li₄Ti₅O₁₂) or titanium niobium oxide (TiNb₂O₇). They may also be silicon-based, lithium-based or sodium-based materials, or tin-based materials and alloys thereof.

Electrically conductive additives are used to improve the electrical conductivity of the electrode. They may be chosen, for example, from carbon fibers, carbon black, carbon nanotubes and mixtures thereof.

One or more additional binders, distinct from said polycarbonate(s) used according to the invention, may be added to improve the cohesion of the various components of the composite electrode, its mechanical strength on the current collector or its flexibility properties. The additional binders may be chosen from fluorinated binders, for example polytetrafluoroethylene (PTFE), polyvinylidene fluoride (PVDF), polysaccharides or latices, notably of the styrene-butadiene rubber (SBR) type.

The ink according to the invention may be obtained by mixing, in one or more solvents, said polycarbonate(s) previously synthesized as described previously, said alkali metal or alkaline-earth metal salt(s), said electrode active material(s), and optionally said conductive additive(s) and/or said additional binder(s).

The invention thus relates, according to another of its aspects, to a process for preparing an ink according to the invention, comprising at least the steps consisting of:

(i) preparation of one or more polycarbonates according to the invention, the hydroxyl functions of which at the end of the chain are optionally protected, in particular according to one or other of the synthetic variants by ROP described previously.

In particular, the preparation of said polycarbonate(s) may be performed according to at least steps (a1) to (a3) as described previously involving an MSA-catalyzed ROP synthesis.

Alternatively, the preparation of said polycarbonate(s) may be performed according to at least steps (b1) to (b3) as described previously, involving microwave irradiation ROP synthesis.

(ii) mixing, in one or more solvents, said polycarbonate(s), said alkali metal or alkaline-earth metal salt(s), said electrode active material(s), and optionally said conductive additive(s) and/or said additional binder(s).

Said solvent(s) may be chosen from organic or aqueous solvents, in particular from N-methyl-2-pyrrolidone (NMP), acetonitrile (ACN), water and mixtures thereof.

The dispersion thus formed, also known as an “ink”, can be homogenized, before being used to form the composite electrode, for example using a deflocculator at a speed of between 2 and 5000 rpm with a deflocculating disc geometry. The value of the shear gradient may range between 10 and 2000 s⁻¹.

### Composite Electrode

The composite electrode according to the invention may be formed on the surface of a current collector via at least the following steps:
preparing an ink as defined previously; and
forming from said ink, on the surface of a current collector, said composite electrode.

The preparation of the ink more particularly comprises the intermediate steps, as described previously, of (i) preparing one or more polycarbonates according to the invention, followed by (ii) mixing, in one or more solvents, said polycarbonate(s), said alkali metal or alkaline-earth metal salt(s), said electrode active material(s), and optionally said conductive additive(s) and/or said additional binder(s).

More particularly, the composite electrode is formed on the surface of a current collector in the form of an electrode layer or film.

The current collector may notably be made of aluminum, copper, nickel or iron. It allows the flow of electrons, and thus electron conduction, in the external circuit. It may be, for example, an aluminum foil optionally coated with carbon.

The formation of the electrode film proceeds more particularly via the following steps:
deposition of the ink on the surface of the current collector, in particular by coating, notably by doctor blade coating; and
evaporation of said ink solvent(s) to form the electrode film.

The ink deposition may be performed via a conventional coating process, for example, with a doctor blade, possibly with a controlled-thickness transfer system, or by a slot die coating system.

The evaporation may be performed by drying, for example in an oven, at a temperature of between 50° C. and 120° C., in particular about 60° C., for a period of between 8 hours and 24 hours, followed by vacuum drying at a temperature of between 60° C. and 120° C., in particular about 80° C., for a period of between 24 hours and 72 hours to completely remove said solvent(s).

The composite electrode layer thus obtained after removal of the solvent(s) adheres to the current collector.

The composite electrode may more particularly comprise from 5% to 30% by weight of (co)polycarbonate(s) according to the invention, in particular between 10% and 25% by weight and more particularly from 12% to 20% by weight, relative to the weight of the electrode.

The weight of the composite electrode is understood to be the weight of the various components of the electrode (polycarbonate(s), electrode active material(s), optionally electrically conductive additive(s) and additional binder(s)), excluding the current conductor, and once said ink solvent(s) have evaporated off. This is also referred to as the dry weight.

Thus, the remainder of the composite electrode may be more particularly formed from one or more active material(s), preferably from at least one electrically conductive additive and possibly one or more additional binders.

Said active material(s) may represent from 60% to 95% by weight, in particular from 70% to 90% by weight, relative to the total weight of the electrode.

Said conductive additive(s), when present, may preferably be used in a content ranging from 1% to 10% by weight, in particular from 2% to 8% by weight, relative to the weight of the electrode.

Said additional binder(s), when present, may be used in a content ranging from 2% to 7% by weight, in particular from 3% to 5% by weight, relative to the total weight of the electrode.

The composite electrode according to the invention, formed on the surface of the current collector, may have a thickness of between 10 μm and 400 μm, in particular between 20 μm and 250 μm.

In particular, the composite electrode comprises less than 1% by weight, for instance less than 0.5% by weight, notably less than 0.1% by weight, of inorganic electrolyte(s), relative to the total weight of the electrode, or even is devoid of inorganic electrolyte. More particularly, the composite electrode comprises less than 1% by weight, for instance less than 0.5% by weight, notably less than 0.1% by weight, of electrolyte(s) distinct from the solid electrolyte based on (co)polycarbonate(s) as used according to the invention, relative to the total weight of the electrode.

Preferably, the composite electrode according to the invention does not comprise an electrolyte distinct from the solid electrolyte based on (co)polycarbonate(s) according to the invention.

### Electrochemical System

A composite electrode prepared according to the invention may be integrated into an electrochemical system.

The electrochemical system may be an electrochemical generator, converter or storage system. More particularly, it may be a primary or secondary battery, for example a lithium, sodium, magnesium, potassium or calcium battery, a redox-flow battery; a lithium-air or lithium-sulfur accumulator, etc.

According to a particular embodiment, the composite electrode according to the invention is used in a rechargeable battery, in particular in a lithium battery, notably a lithium-ion or lithium-metal battery.

An electrochemical system according to the invention generally includes at least one positive and one negative electrode with an electrolyte between them acting as an ion conductor between the positive and negative electrodes.

The composite electrode according to the invention may form the positive electrode and/or the negative electrode of the electrochemical system. It may form, for example, the positive electrode.

In the particular case of a lithium metal battery, the composite electrode is the positive electrode, the negative electrode being made of lithium metal.

In other cases of batteries, the positive electrode and the negative electrode may preferably both be composite electrodes according to the invention.

The electrode different from a composite electrode, possibly used together with a composite electrode according to the invention in an electrochemical system, may be of conventional nature.

The electrolyte between said composite electrode and said second electrode of an electrochemical system according to the invention may be of diverse nature. It is preferably a solid electrolyte film.

In the text hereinbelow, the expression “separating electrolyte” will be used more simply to denote the layer or film of solid electrolyte intended to act as a separator between the positive and negative electrodes of an electrochemical system.

Preferably, the solid separating electrolyte is of the same nature as the solid electrolyte incorporated into the composite electrode according to the invention used for the electrochemical system.

In other words, the separating electrolyte in an electrochemical system according to the invention may be a film (also known as a membrane) of solid electrolyte based on one or more polycarbonates as used for the preparation of said composite electrode.

The separating electrolyte may be a solid polymer electrolyte (SPE) or a hybrid solid electrolyte (HSE).

The solid electrolyte film, notably of the solid polymer electrolyte (SPE) or hybrid solid electrolyte (HSE) type, acting as a separating electrolyte in an electrochemical system according to the invention, may thus comprise, or even be formed from:
at least one (co)polymer obtained by ROP of at least one five- to eight-membered cyclic carbonate;
   said (co)polymerization reaction being catalyzed with methanesulfonic acid or performed under microwave irradiation in the absence of a catalyst, in particular according to the conditions described previously for the preparation of a composite electrode according to the invention;
   and the hydroxyl functions at the end of the chain of which are optionally protected;
at least one alkali metal or alkaline-earth metal salt, in particular as described previously, notably a lithium salt; and
optionally at least one inorganic filler which conducts alkali or alkaline-earth cations, in particular an inorganic filler which conducts lithium ions.

The separating electrolyte based on said polycarbonate(s) may be prepared from said polycarbonate(s) according to the invention, obtained according to the conditions described previously, via at least the following steps:
mixing, in the presence or absence of a solvent medium, of said polycarbonate(s) synthesized according to the invention, with at least one alkali metal or alkaline-earth metal salt, in particular a lithium salt, and, optionally, at least one inorganic filler which conducts alkali or alkaline-earth cation or cations, in particular an inorganic filler which conducts lithium ions; and
formation, in particular on the surface of a substrate, of a solid electrolyte, notably in the form of a film, from said mixture.

According to a first particular embodiment, the separating electrolyte is a solid polymer electrolyte (SPE), the preparation of said separating electrolyte comprising the mixing of at least one polycarbonate synthesized according to the invention and of at least one alkali metal or alkaline-earth metal salt, as described previously, for example a lithium salt.

According to another particular embodiment, said polycarbonate(s) according to the invention are used to form a hybrid solid electrolyte (HSE), the preparation of said separating electrolyte then comprising the mixing of at least one polycarbonate synthesized according to the invention, of at least one alkali metal or alkaline-earth metal salt, for example a lithium salt, and, in addition, of at least one inorganic filler which conducts alkali metal or alkaline-earth metal cation(s), in particular which conducts lithium ions. The lithium-ion-conducting fillers may be chosen, for example, from lithiated oxides, such as Li₇La₃Zr₂O₁₂ (LLZO) and Li_{0.33}La_{0.56}TiO₃ (LLTO), Li_{1.3}Al_{0.3}Ti_{1.7}(PO₄)₃ (LATP), etc.

They may also be fillers chosen from:
garnets, for example chosen from Li₇La₃Zr₂O₁₂, Li₆La₂BaTa₂O₁₂, etc.;
lithiated phosphates, for example chosen from Li₃PO₄, LiPO₃, etc.;
lithiated borates, for example chosen from Li₃BO₃, etc.;
oxynitrides, for example chosen from Li₃PO₄₋ₓN_{2x/3}, Li₄SiO₄₋ₓN_{2x/3}, Li₄GeO₄₋ₓN_{2x/3} with 0<x<4 or Li₃BO₃₋ₓN_{2x/3} with 0<x<3;
lithiated compounds based on lithium phosphorus oxynitride (known as LiPON);
silicates, for example Li₂Si₂O₅.

Said ion-conducting inorganic filler(s) may be used in a conductive filler(s)/polycarbonate(s) volume ratio of between 10/90 and 90/10, in particular between 20/80 and 60/40.

The mixing of said polycarbonate(s), said alkali metal or alkaline-earth metal salt(s) and, optionally, said conductive inorganic filler(s), is more particularly performed under conditions allowing good dispersion of said alkali metal or alkaline-earth metal salts and, optionally, of said conductive inorganic filler(s), in the polycarbonates according to the invention.

According to a first implementation variant, the separating electrolyte is prepared by the “solvent” route. In this variant, the mixing of said polycarbonate(s) according to the invention, of said alkali metal or alkaline-earth metal salt(s) and, optionally, of said conductive inorganic filler(s), is more particularly performed in a solvent medium. The solvent medium may be formed from one or more polar organic solvents. As examples, they may be chosen from acetone, acetonitrile (ACN), tetrahydrofuran (THF) and mixtures thereof, in particular acetone or acetonitrile.

The solid electrolyte may be formed by depositing said mixture on the surface of a substrate, for example by coating, followed by evaporation of said solvent(s), in particular to obtain a “dry” electrolyte or film.

The term “dry” means that the separating electrolyte or separating electrolyte film comprises less than 1.0% by mass of solvent, in particular less than 0.5% by mass and more particularly less than 0.2% by mass of solvent.

The evaporation of said solvent(s) may be performed, for example, by oven drying at a temperature of between 50° C. and 120° C., in particular about 60° C., for a period of between 8 hours and 24 hours, followed by vacuum drying at a temperature of between 60° C. and 120° C., in particular between 80° C. and 100° C., for a period of at least 24 hours, in particular between 24 hours and 72 hours, in order to completely remove the solvent.

According to another implementation variant, the separating electrolyte is prepared in the absence of solvent, by “melting”, notably by extrusion.

In this implementation variant, the melt blending may be performed more particularly by heating to a temperature above Tg+30° C., where Tg is the glass transition temperature of the (co)polymer. In particular, the blending is performed at a temperature of greater than or equal to 30° C., in particular between 40° C. and 100° C.

The molten mixture may then be formed into a film, supported by a substrate or self-supported, by any melt extrusion technique known to a person skilled in the art. Thus, in a particularly advantageous embodiment, the preparation of the separating electrolyte totally dispenses with the use of solvent.

As mentioned previously, the solid electrolyte, intended to act as a separating electrolyte in an electrochemical system according to the invention, may be prepared on the surface of a suitable substrate.

According to a first implementation variant, the substrate on the surface of which a solid electrolyte film according to the invention is formed may be an inert substrate.

The substrate may be of diverse nature. It may be made of glass, alumina, silicone, polyimide, polytetrafluoroethylene (PTFE), polyethylene terephthalate (PET), silicone or polypropylene.

The solid electrolyte film may optionally be detached from the substrate in order to be used in the electrochemical system for which it is intended, in particular transferred onto the surface of at least one composite electrode according to the invention.

According to another implementation variant, the solid electrolyte film may be formed directly on the surface of one of the electrodes of the electrochemical system, for example on the surface of a composite electrode according to the invention or of the metallic lithium electrode.

In particular, the solid electrolyte film may be formed by the solvent route as described previously, notably by coating the mixture as described previously on the surface of one of the electrodes, for example on the surface of the composite electrode, followed by evaporation of said solvent(s).

The separating electrolyte film may have a thickness of, for example, between 20 and 500 μm, in particular between 20 and 250 km.

The invention also relates, according to another of its aspects, to an electrode/electrolyte membrane assembly, in which said electrode is a composite electrode according to the invention, as defined previously or prepared according to the process described previously, said electrolyte membrane more particularly being a solid electrolyte film, notably of the solid polymer electrolyte or hybrid solid electrolyte type, preferably based on one or more (co)polymers such as are used in said composite electrode.

As described previously, according to a particular embodiment, an electrode/electrolyte membrane assembly can be obtained by forming a film of solid electrolyte according to the invention, as described previously, directly on the surface of said composite electrode according to the invention.

The invention will now be described by means of the examples that follow, which are, needless to say, given as nonlimiting illustrations of the invention.

### EXAMPLE

In the examples that follow, the following products are used.

For the synthesis of the (co)polymers:

Trimethylene carbonate (TMC, 99.5%, Actu-All Chemicals) dried under vacuum at 40° C. before use; ε-caprolactone (CL, 97%); 3-phenylpropanol (PPA, 98%); ethylene glycol (EG, 99.8%); stannous octanoate (Sn(Oct)₂, 92.5-100%); methanesulfonic acid (MSA, 99.5%); benzoyl chloride (BC, 99%); p-toluenesulfonyl isocyanate (TSI, >98%), sold by Sigma-Aldrich, are used as is; triethylamine (TEA, >99%, Alfa Aesar) is used as is; dichloromethane (DCM, HPLC grade, Sigma-Aldrich) is distilled from calcium hydride (CaH₂) before use; methanol (MeOH, HPLC grade); anhydrous toluene, sold by Sigma-Aldrich, are used as is.

For the preparation of the electrolytes:

The lithium salts, lithium bis(trifluoromethanesulfonyl)imide (LiTFSI, 99.9%, Sigma-Aldrich); lithium bis(fluorosulfonyl)imide (LiFSI, 99.9%, Arkema); 4,5-dicyano-2-(trifluoromethyl)imidazole (LiTDI, 95%, Alfa Aesar), are dried under vacuum for 72 hours and stored in a glove box filled with argon. Anhydrous acetone (≥99.8%) and acetonitrile (HPCL grade, ≥99.9%), sold by Sigma-Aldrich, are used as is. NASICON Li_{1.3}Al_{0.3}Ti_{1.7}P₃O₁₂ (LATP) conductive ceramic, sold by Schott AG, is used as is unless otherwise specified.

For the preparation of the electrodes:

Lithium nickel cobalt manganese oxide LiNi_{0.6}Mn_{0.2}Co_{0.2}O₂(NMC622) is dried at 120° C. under vacuum for 12 hours and stored in a glove box filled with argon. Carbon black C65 (Super P), sold by MTI Corporation, is used as is. Polyvinylidene fluoride PVdF (Solef® 5130), sold by Solvay, is dried at 60° C. under vacuum before use. N-Methyl-2-pyrrolidone (NMP), sold by Sigma-Aldrich, is used as is.

### Example 1

### Synthesis of PTCM Homopolymers by ROP Using Different Synthetic Methods

1.1. Synthesis of PTMC Using Methanesulfonic Acid as Catalyst and Initiated with a Monoalcohol

The following protocol is followed for the ROP synthesis, using the catalyst MSA and initiated with a monoalcohol (3-phenylpropanol, PPA), of PTMC, with a theoretical molecular mass of 10 000 g·mol⁻¹.

The monomer TMC (10.000 g; 97.95 mmol, 96.62 equivalents) is introduced into a 100 mL two-necked round-bottom flask equipped with a magnetic stirrer, condenser and argon inlet/outlet. DCM (20 mL) is then added to dissolve the TMC. The monomer concentration is approximately 5 M. Once the TMC is fully dissolved, the initiator PPA (136.7 μL, 1.01 mmol, 1 equiv.) and the catalyst MSA (65.8 μL, 1.01 mmol, 1 equiv.) are introduced directly into the reaction medium. The initiator/catalyst [PPA]/[MSA] mole ratio is 1:1. The reaction mixture is stirred for 24-48 hours at room temperature.

The reaction mixture is then poured into 300 mL of cold methanol with vigorous stirring to precipitate the polymer and to remove the DMC and MSA catalyst. After two hours of stirring, the PTMC, obtained in the form of a white gum, named “P10PPA”, is washed several times with methanol to neutral pH. The polymer is then dried in an oven at 60° C. for 24 hours, then under vacuum at 80° C. for 48 hours. The purity of the final product is checked by ¹H NMR; no traces of the catalyst or of byproducts are visible in the spectrum obtained.

The same synthetic protocol as above is used to synthesize a PTMC polymer with a theoretical molecular mass of about 50 000 g·mol⁻¹, named “P50PPA”, using the following amounts of reagents: TMC (10.000 g, 97.95 mmol; 488.43 equiv.), PPA (27.0 μL, 0.20 mmol, 1 equiv.) and MSA (13.0 μL, 0.2 mmol, 1 equiv.). The reaction time is increased to 48 hours to achieve high monomer conversion.

The reaction scheme for the MSA-catalyzed and PPA-initiated synthesis of PTMC is shown below.

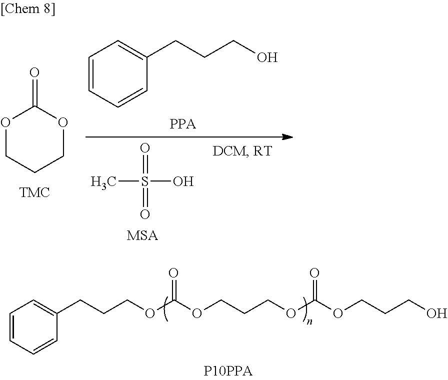

1.2. Synthesis of PTMC Using Methanesulfonic Acid as Catalyst and Initiated with a Diol

The following protocol is followed for the ROP synthesis, using the catalyst MSA and initiated with a diol (ethylene glycol, EG), of PTMC, with a theoretical molecular mass of 10 000 g·mol⁻¹.

The monomer TMC (10.000 g; 97.95 mmol, 96.62 equivalents) is introduced into a 100 mL two-necked round-bottom flask equipped with a magnetic stirrer, condenser and argon inlet/outlet. DCM (20 mL) is then added to dissolve the TMC. The monomer concentration is approximately 5 M.

Once the TMC is fully dissolved, ethylene glycol (EG, 56.1 μL, 1.01 mmol, 1 equiv.) and the catalyst MSA (65.8 μL, 1.01 mmol, 1 equiv.) are introduced into the reaction medium. The reaction mixture is stirred for 48 hours at room temperature. The same procedure as described previously in section 1.1. for the synthesis of P10PPA is then applied to obtain the polymer named “P10EG”.

The same synthetic protocol is used for the synthesis of PTMC with a theoretical molecular mass of about 50 000 g·mol⁻¹, initiated with ethylene glycol (named “P50EG”).

The reaction scheme for the synthesis of PTMC catalyzed with MSA and initiated with ethylene glycol is shown below.

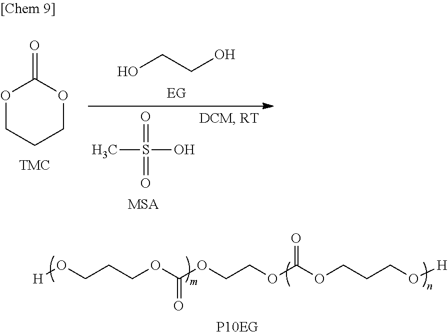

### 1.3. Synthesis of PTMC Using Methanesulfonic Acid as Catalyst and in the Absence of Initiator

The following protocol is followed for the ROP synthesis, using the catalyst MSA and without initiator, of PTMC, with a theoretical molecular mass of 10 000 g·mol⁻¹.

The monomer TMC (10.000 g; 97.95 mmol, 96.62 equivalents) is introduced into a 100 mL two-necked round-bottom flask equipped with a magnetic stirrer, condenser and argon inlet/outlet. DCM (20 mL) is then added to dissolve the TMC. The monomer concentration is approximately 5 M.

Once the TMC is fully dissolved, the catalyst MSA (65.8 μL, 1.01 mmol, 1 equiv.) is introduced directly into the reaction medium. The reaction mixture is stirred for 48 hours at room temperature. The same protocol as described previously in section 1.2. for the synthesis of P10EG is then applied to obtain the polymer, named “PxMSA”. In this synthetic route, the molar mass of the polymer is uncontrollable.

The reaction scheme for the MSA-catalyzed synthesis of PTMC without initiator is shown below.

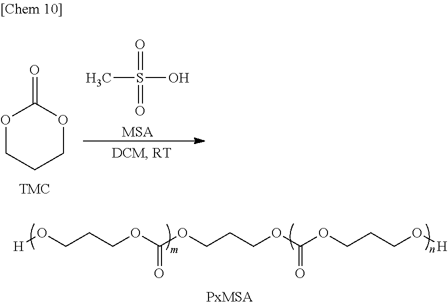

1.4. Synthesis of PTMC by ROP Under Microwave Irradiation, Initiated with PPA, without Catalyst, in the Presence of a Solvent Medium

The following protocol is followed for the synthesis by ROP, in solvent medium, under microwave irradiation, without catalyst, and initiated with a monoalcohol (PPA), of PTMC, with a theoretical molecular mass of 10 000 g·mol⁻¹.

The monomer TMC (10.000 g; 97.95 mmol, 96.62 equiv.) and the initiator PPA (136.7 μL, 1.01 mmol, 1 equiv.) are introduced into an XP1500 PTFE reactor in a glove box filled with argon. A small amount of anhydrous toluene (1 mL/10 g TMC) is added to the reaction mixture prior to the application of microwave irradiation. The reactor is closed, taken out and subjected to microwave irradiation using a CEM Mars microwave oven (2.45 GHz).

A controlled temperature program allows a specific temperature of 140° C. to be reached with a 10 minute ramp and to maintain this temperature for 60 minutes, with a power constraint limited to Pₘₐₓ=60 W. The reaction temperature is then reduced to room temperature and the polymer dissolved in a minimum amount of DCM, then precipitated from 300 mL of methanol with vigorous stirring to remove the unreacted monomers. The methanol is freshened after 2 hours with stirring.

After 4 hours, the PTMC, obtained in the form of a white gum, named “MW10PPA-T”, is dried under vacuum at 80° C. for 48 hours.

The same synthetic protocol is followed for the synthesis of a PTMC polymer with a theoretical molecular mass of about 50 000 g·mol⁻¹, named “MW50PPA-T”, using the following amounts of reagents: TMC (10.000 g, 97.95 mmol; 488.43 equivalents) and PPA (27.0 μL, 0.20 mmol, 1 equiv.).

The reaction scheme for the synthesis of MW10PPA-T is shown below.

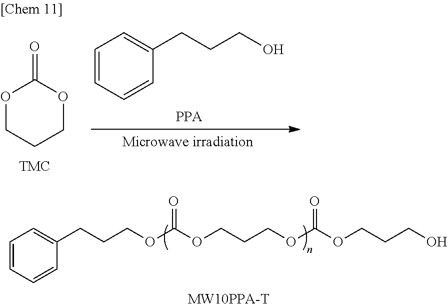

1.5. Synthesis of PTMC by ROP Under Microwave Irradiation, Initiated with PPA, without Catalyst, and in the Absence of Solvent

The following protocol is followed for the bulk synthesis (without solvent medium) by ROP, under microwave irradiation, without catalyst, and initiated with a monoalcohol (PPA), of PTMC, with a theoretical molecular mass of 10 000 g·mol⁻¹.

The monomer TMC (10.000 g; 97.95 mmol, 96.62 equiv.) and the initiator PPA (136.7 μL, 1.01 mmol, 1 equiv.) are introduced into an XP1500 PTFE reactor in a glove box filled with argon. The reactor is closed, taken out and subjected to microwave irradiation using a CEM Mars microwave oven (2.45 GHz).

A controlled temperature program allows a specific temperature of 140° C. to be reached with a 10 minute ramp and to maintain this temperature for 60 minutes, with a power constraint limited to Pₘₐₓ=60 W. The reaction temperature is then reduced to room temperature and the polymer dissolved in a minimum amount of DCM, then precipitated from 300 mL of methanol with vigorous stirring to remove the unreacted monomers. The methanol is freshened after 2 hours with stirring.

After 4 hours, the PTMC, obtained in the form of a white gum, named “MW10PPA”, is dried under vacuum at 80° C. for 48 hours.

The same synthetic protocol is followed for the synthesis of a PTMC polymer with a theoretical molecular mass of about 50 000 g·mol⁻¹, named “MW50PPA”, using the following amounts of reagents: TMC (10.000 g, 97.95 mmol; 488.43 equivalents) and PPA (27.0 μL, 0.20 mmol, 1 equiv.).

The reaction scheme for the synthesis of MW10PPA is shown below.

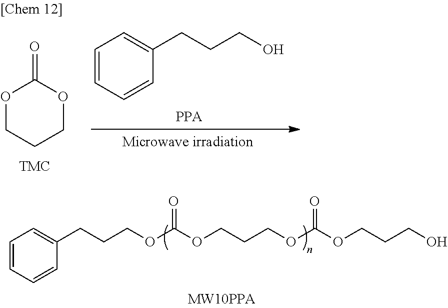

1.6. Synthesis of PTMC by ROP Under Microwave Irradiation, without Addition of Initiator, without Catalyst and without Solvent

The following protocol is followed for the bulk synthesis (without solvent medium) by ROP, under microwave irradiation, without catalyst, of PTMC, with a theoretical molecular mass of 10 000 g·mol⁻¹. No initiator is added to the starting reaction medium. The ROP is initiated with the residual water provided by the monomer.

The monomer TMC (10.000 g; 97.95 mmol) is introduced into an XP1500 PTFE reactor in a glove box filled with argon. The reactor is closed, taken out and subjected to microwave irradiation using a CEM Mars microwave oven (2.45 GHz).

A controlled temperature program allows a specific temperature of 140° C. to be reached with a 10 minute ramp and this temperature to be maintained for 60 or 120 minutes, with a power constraint limited to Pₘₐₓ=60 W. The reaction temperature is then reduced to room temperature and the polymer is dissolved in a minimum amount of DCM and then precipitated from 300 mL of methanol with vigorous stirring to remove the unreacted monomers. The methanol is freshened after 2 hours with stirring.

After 4 hours, the PTMC, obtained in the form of a white gum, named “MWx”, is dried under vacuum at 80° C. for 48 hours.

The reaction scheme for the synthesis of MWx is shown below.

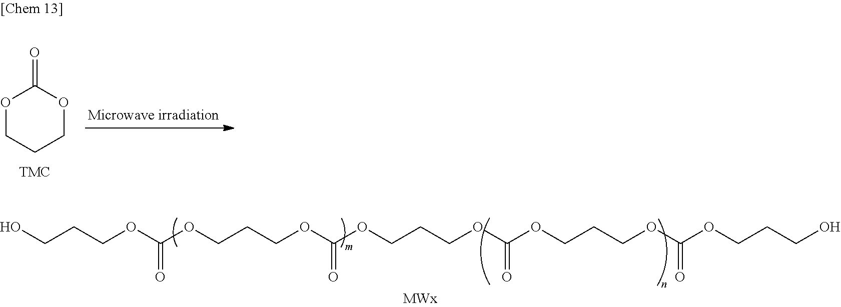

### 1.7. Protection of PTMC Bearing a Terminal Hydroxyl Function Using Different Protecting Agents

In a typical procedure, P10PPA (10.00 g, 0.001 mol, 1 equiv.) was introduced into a 100 ml single-necked round-bottomed flask with a magnetic stirrer in an argon-filled glove box. Distilled DCM (20 ml) was then added to dissolve the polymer. For protection with benzoyl chloride (BC), TEA (1.395 ml, 0.01 mol, 10 equiv.) and BC (1.162 ml, 0.01 mol, 10 equiv.) were introduced and the reaction was allowed to proceed at room temperature for 48 hours. For protection with p-toluenesulfonyl isocyanate (TSI), TSI (1.528 ml, 0.01 mol, 10 equiv.) was introduced and the reaction was allowed to proceed at room temperature for 48 hours.

The reaction mixture was then introduced dropwise into 300 ml of methanol to precipitate the polymer and react with the residual protecting agent. The resulting polymer was washed with methanol until no trace of the byproducts (methyl benzoate, urethane, etc.) was detected by ¹H NMR. The final products, named P10PPA-BC and P10PPA-TSI, the hydroxyl functions of which are protected with benzoyl chloride or p-toluenesulfonyl isocyanate, respectively, were dried under vacuum at 80° C. for 48 hours and stored in a glove box.

The same protocol with the same mole ratio of protecting agent used is used for the protection of the other PTMCs (P50PPA, MW10PPA-T, MW50PPA-T, MW10PPA, MW50PPA) bearing an OH function at the end of the chain.

The reaction scheme for the protection of P10PPA is shown below.

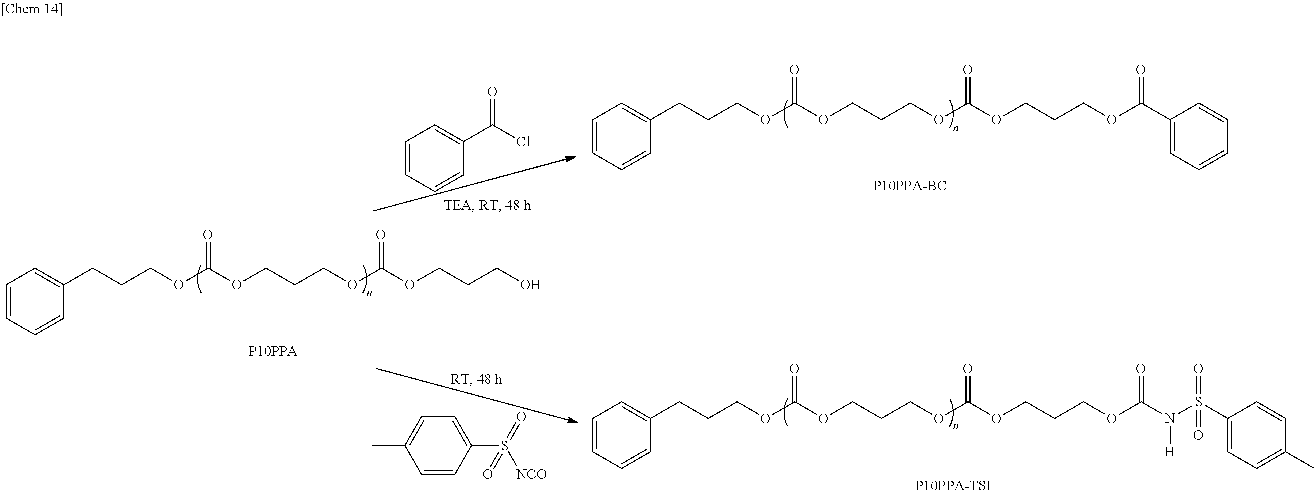

### 1.8. Protection of PTMC Bearing Two Terminal OH Functions Using Different Protecting Agents

In a typical procedure, P10EG (10.00 g, 0.001 mol, 1 equiv.) was introduced into a 100 ml single-necked round-bottom flask equipped with a magnetic stirrer in an argon-filled glove box. Distilled DCM (20 ml) was then added to dissolve the polymer. For protection with benzoyl chloride (BC), TEA (2.790 ml, 0.02 mol, 20 equiv.) and BC (2.324 ml, 0.02 mol, 20 equiv.) were introduced and the reaction was allowed to proceed at room temperature for 48 hours. For protection with p-toluenesulfonyl isocyanate (TSI), TSI (3.056 ml, 0.02 mol, 20 equiv.) was introduced and the reaction was allowed to proceed at room temperature for 48 hours.

The reaction mixture was then introduced dropwise into 300 ml of methanol to precipitate the polymer and react with the residual protecting agent. The resulting polymer was washed with methanol until no trace of the byproducts (methyl benzoate, urethane, etc.) was detected by ¹H NMR. The final products, named P10EG-BC and P10EG-TSI, the hydroxyl functions of which are protected with benzoyl chloride or p-toluenesulfonyl isocyanate, respectively, were dried under vacuum at 80° C. for 48 hours and stored in a glove box.

The same protocol with the same mole ratio of protecting agent used is used for the protection of the other PTMCs (P50EG, MWx) bearing two terminal hydroxyl functions.

The reaction scheme for the protection of P10EG is shown below.

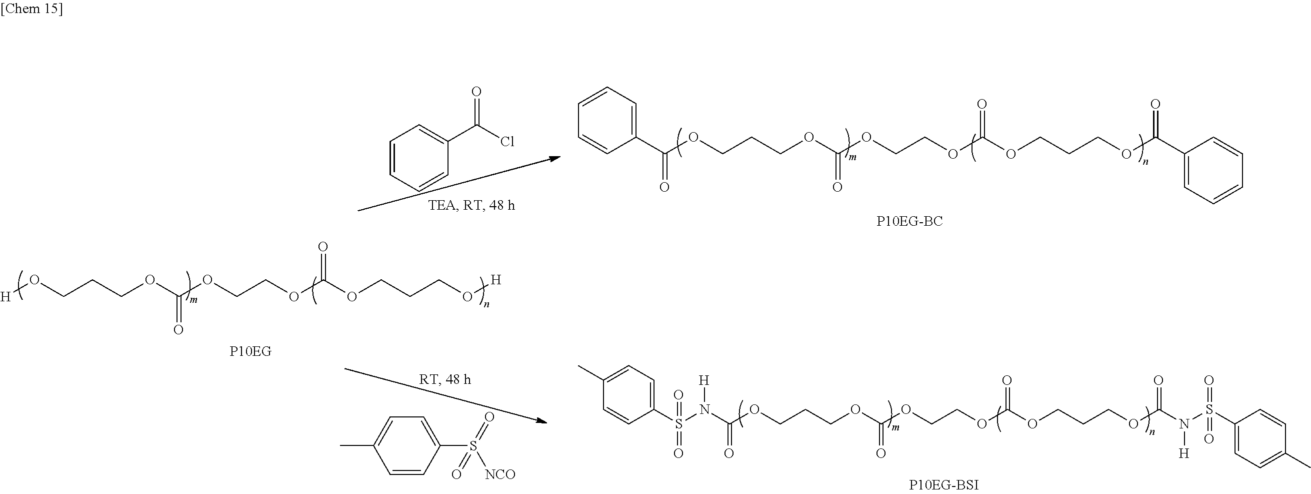

### 1.9. Synthesis of PTMC Using Sn(Oct)₂ as Catalyst (Comparative)

The following protocol is followed for the ROP synthesis, using the catalyst Sn(Oct)₂ and initiated with a monoalcohol (PPA), of PTMC, with a theoretical molecular mass of 10 000 g·mol⁻¹.

The monomer TMC (10.000 g, 97.95 mmol, 96.62 equiv.), the initiator PPA (136.7 μL, 1.01 mmol, 1 equiv.) and a 1 M solution of the catalyst Sn(Oct)₂ dissolved in anhydrous toluene (20.0 μL, 2.0×10⁻² mmol; 0.02 equiv.) are introduced into a 100 mL single-necked round-bottom flask, working in a glove box filled with argon. The monomer/catalyst [TMC]/[Sn(Oct)₂] mole ratio is approximately 5000:1. The flask is closed, taken out and heated to 130° C. using an oil bath with vigorous stirring. The temperature of the bath is maintained at 130° C. for 24 hours.

The reaction mixture is then cooled to room temperature and a minimum amount of DCM is added to dissolve the PTMC polymer. The polymer solution is then poured into 300 mL of cold methanol with vigorous stirring to precipitate the polymer.

The polymer mass, in the form of a white gum, is washed several times with methanol and then dried in an oven at 60° C. followed by vacuum drying at 80° C. for 48 hours to obtain the final product, named “S10PPA”.

The same synthetic protocol is followed for the synthesis of a PTMC polymer with a theoretical molecular mass of about 50 000 g·mol⁻¹, named “S50PPA”, using the following amounts of reagents: TMC (10.000 g, 97.95 mmol; 488.43 equiv.), PPA (27.0 μL, 0.20 mmol, 1 equiv.) and a 1 M solution of the catalyst Sn(Oct)₂ dissolved in anhydrous toluene (20.0 μL, 2.0×10⁻² mmol, 0.1 equiv.). The mole ratio of monomer to catalyst is about 5000:1. The reaction time was increased to 48 hours to achieve high monomer conversion.

The reaction scheme for the synthesis of the PTMC is shown below.

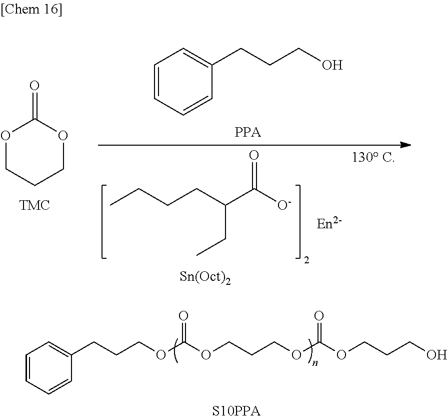

### Results

### Polymer Characterization Methods

NMR spectroscopy: The chemical structure of the monomers and polymers is confirmed by NMR spectroscopy on a Bruker Ascend™ 400 NMR spectrometer.

Molecular weight (Mw) measurement: The SEC-MALS analyses (combination of size exclusion chromatography and static light scattering techniques) were performed on a Viscotek GPCmax machine (VE 2001 Module) and the data were processed by the OmniSEC software, sold by Malvern Panalytical. The measurements were taken at room temperature and tetrahydrofuran (THF) was used as the solvent with a flow rate of 1 mL·min⁻¹. The polymer solutions (at about 1 mg·mL⁻¹) were filtered through a 0.20 m Millipore PTFE filter. Calibration was performed using polystyrene standards.

Thermal properties: The DSC (“Differential Scanning Calorimetry”) measurements were performed on dry ionomer films using a Chip-DSC 100 system (Linseis) under argon flow of 50 m/min with a heating rate of 10° C.·min⁻¹ from −100 to 100° C. The glass transition temperature (Tg) is determined as the midpoint value on the second scan.

### Results

The results of the analyses of the PTMC polymers obtained by different synthetic methods are presented in Table 1 below.

TABLE 1

| | Yield | M_{n-RMN} | M_{n-SEC} | M_{w-SEC} | |
|---|---|---|---|---|---|
| Sample | (%)^{a} | (Da)^{b} | (Da)^{c} | (Da)^{c} | PDI^{d} |
| S10PPA | 95 ± 3 | 9700 ± 1000 | 8700 ± 500 | 21500 ± 3000 | 2.45 ± 0.05 |
| (Outside the invention) | | | | | |
| S50PPA | 95 ± 3 | 24600 ± 2000 | 24000 ± 1500 | 55000 ± 2000 | 2.31 ± 0.05 |
| (Outside the (mention) | | | | | |
| P10PPA | 97 ± 2 | 8400 ± 500 | 8900 ± 1000 | 10700 ± 1400 | 1.19 ± 0.02 |
| P50PPA | 97 ± 2 | 24900 ± 2000 | 19900 ± 1700 | 24600 ± 1600 | 1.24 ± 0.02 |
| P10EG | 99 ± 2 | 8000 ± 500 | 11101 ± 1000 | 12626 ± 1500 | 1.14 ± 0.02 |
| PxMSA | 93 ± 2 | // | 19400 ± 2000 | 20800 ± 2000 | 1.07 ± 0.02 |
| MW10PPA-T | 95 ± 3 | 8900 ± 1000 | 8100 ± 1000 | 15500 ± 3000 | 1.91 ± 0.05 |
| MW50PPA-T | 95 ± 3 | 21300 ± 3000 | 22800 ± 3000 | 50400 ± 3000 | 2.21 ± 0.05 |
| MW10PPA | 88 ± 3 | 9500 ± 1000 | 8700 ± 1000 | 21800 ± 2000 | 2.50 ± 0.05 |
| MW50PPA | 90 ± 3 | 26600 ± 3000 | 24000 ± 3000 | 46900 ± 3000 | 1.96 ± 0.05 |
| MWx | 90 ± 3 | 10100 ± 2000 | 13000 ± 1500 | 23300 ± 2000 | 1.79 ± 0.03 |

^{a}The conversion yield is calculated from the mass of PTMC polymer obtained (m_{PTMC}) and the masses of TMC monomer and, optionally, of the starting initiator PPA or EG, according to the formula
[Math 1]
yield (%) = m_{PTMC} × 200/(m_{TMC} + m_{PPA or EG})
^{b}The number-average molecular mass is calculated by ¹H NMR analysis;
^{c}The average molecular mass is measured by SEC;
^{d}Polydispersity index PDI = M_{W}/Mₙ

The ¹H NMR analyses of the PTMC polymers synthesized by ROP and initiated with PPA using the catalyst MSA (P10PPA), Sn(Oct)₂ catalyst (S10PPA), or without catalyst using microwave irradiation in the presence of toluene (MW10PPA-T), are shown in FIG. 1. All ¹H NMR spectra of the synthesized polymers show two main peaks at 4.20 and 2.03 ppm corresponding to the proton of the —CH₂—O— and —CH₂— groups, respectively, of the TMC unit.

The ¹H NMR spectrum of the PTMC synthesized using the catalyst Sn(Oct)₂ shows a peak at 3.43 ppm. This peak indicates the presence of ether bonds (—CH₂—O—CH₂—) due to undesirable high-temperature decarboxylation reactions in the presence of Sn(Oct)₂ ([11], [12]).

In contrast, this peak is not detected in the ¹H NMR spectrum of the PTMC synthesized by ROP with the catalyst MSA according to the invention. For comparative purposes, the integration ratio of the 3.43 ppm peak to the 4.20 ppm peak in S10PPA is 16.9/1000, whereas no trace of the 3.43 ppm peak was detected in the spectra of P10PPA (0/1000). Considering that an ether bond is derived from the decarboxylation of a TMC unit, the molar concentration of ether bond in S10PPA is about 1.67% while that of P10PPA is 0.00%.

The 3.43 ppm peak also appears in the H NMR spectrum of the PTMC synthesized using microwave irradiation. However, the intensity of this peak is very low. For comparative purposes, the integration ratio of the 3.43 ppm peak to the 4.20 ppm peak in MW10PPA-T is 5.7/1000, which corresponds to a molar ether bond concentration of 0.57%. Polymerization using an MSA catalyst shows higher controllability (PDI closer to 1, fewer defects in the chemical structure), easier purification, lower energy consumption and is more readily transposable to large-scale production compared to conventional synthesis using the catalyst Sn(Oct)₂.

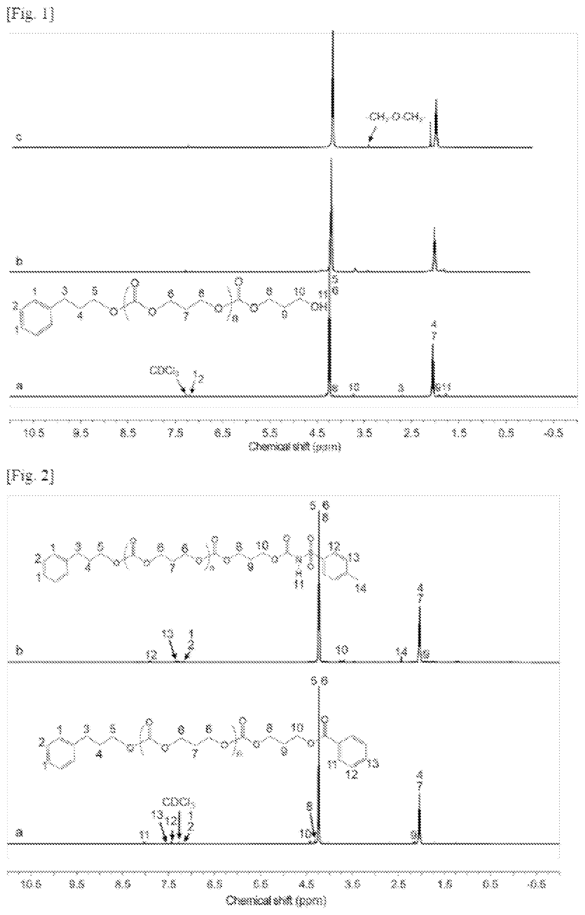

The ¹H NMR analyses of the “protected” PTMC polymers with an average molecular mass Mn of about 10 000 g·mol⁻¹ using the protecting agent benzoyl chloride (P10PPA-BC) and p-toluenesulfonyl isocyanate (P10PPA-TSI), are shown in FIG. 2.

The appearance of new peaks corresponding to the protecting agents in the ¹H NMR spectra of the protected PTMCs reveals that the protections were successfully achieved using benzoyl chloride and p-toluenesulfonyl isocyanate. In particular, three new peaks, which appear at 8.03, 7.56 and 7.43 ppm (peaks 11, 12 and 13) in FIG. 2(a), are attributed to the three protons on the aromatic ring of benzoyl chloride. In addition, due to the electron-withdrawing effect of the benzoate group attached to the polymer chain, three protons at the end of the polymer chain shift to higher ppm values (peaks 8, 9 and 10 in FIG. 2(a)).

Similarly, two new peaks appearing at 7.89 and 7.34 ppm (peaks 12 and 13 in FIG. 2(b)) correspond to the two protons on the aromatic ring of p-toluenesulfonyl isocyanate. In addition, a very small peak appearing at 8.16 ppm (peak 11 in FIG. 2(b)) is derived from the proton of the urethane group of the coupling product. Finally, a singlet appearing at 2.44 ppm is derived from the methyl group attached to the aromatic ring of the TSI agent. The ¹H NMR spectra reveal that the coupling reactions were successfully performed.

### Example 2

### Synthesis of PTCM-PCL Copolymers by ROP Using Different Synthetic Methods

2.1. Synthesis of PTMC-PCL Copolymer Using Methanesulfonic Acid as Catalyst and Initiated with a Monoalcohol

The following protocol is followed for the synthesis by ROP, using the catalyst MSA and initiated with a monoalcohol (3-phenylpropanol, PPA), of PTMC-PLC, with a theoretical molecular mass of 10 000 g·mol⁻¹.

The monomers TMC (5.702 g; 55.85 mmol, 55.36 equiv.) and CL (4.250 g, 37.23 mmol, 36.91 equiv.) are introduced into a 100 mL two-necked round-bottom flask equipped with a magnetic stirrer, condenser and argon inlet/outlet. DCM (20 mL) is then added to dissolve the TMC. The monomer concentration is about 5 M. Once the TMC is fully dissolved, the initiator PPA (136.0 μL, 1.01 mmol, 1 equiv.) and the catalyst MSA (65.5 μL, 1.01 mmol, 1 equiv.) are introduced directly into the reaction medium. The initiator/catalyst [PPA]/[MSA] mole ratio is 1:1. The reaction mixture is stirred for 24-48 hours at room temperature.

The reaction mixture is then poured into 300 mL of cold methanol with vigorous stirring to precipitate the copolymer and remove the DCM and MSA catalyst. After two hours of stirring, the resulting copolymer, in the form of a white gum, named “G10PPA”, is washed several times with methanol to neutral pH. The copolymer is then dried in an oven at 60° C. for 24 hours, then under vacuum at 80° C. for 48 hours.

The same synthetic protocol as above is used for the synthesis of an “unprotected” PTMC-PCL copolymer with a theoretical molecular mass of about 50 000 g·mol⁻¹, named “G50PPA”, using the following amounts of reagents: TMC (5.702 g; 55.85 mmol, 279.85 equiv.), CL (4.250 g, 37.23 mmol, 186.56 equiv.), PPA (26.9 μL, 0.20 mmol, 1 equiv.) and MSA (13.0 μL, 0.20 mmol, 1 equiv.). The reaction time was increased to 48 hours to achieve high monomer conversion.

The reaction scheme for the synthesis of PTMC-PCL copolymers initiated with PPA is shown below.

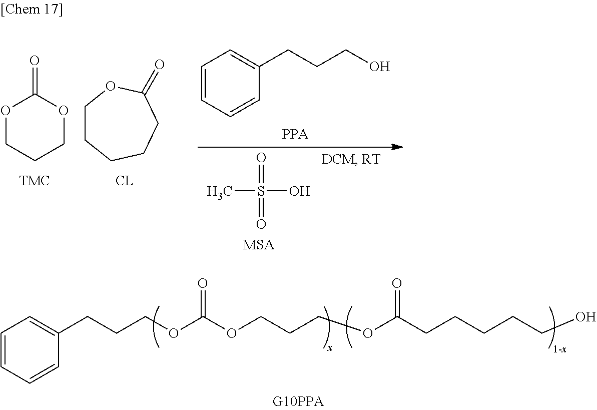

2.2. Synthesis of PTMC-PCL Copolymer by ROP Under Microwave Irradiation, Initiated with PPA, without Catalyst, in the Presence of a Solvent Medium

The following protocol is followed for the synthesis by ROP, in solvent medium, with microwave irradiation, without catalyst and initiated with a monoalcohol (PPA), of PTMC-PCL, with a theoretical molecular mass of 10 000 g·mol⁻¹.

The monomers TMC (6.037 g; 59.14 mmol, 55.36 equiv.) and CL (4.500 g, 39.43 mmol, 36.91 equiv.) and the initiator PPA (144.0 μL, 1.07 mmol, 1 equiv.) are introduced into an XP1500 PTFE reactor in a glove box filled with argon. A small amount of anhydrous toluene (1 mL/10 g TMC) is added to the reaction mixture prior to the application of microwave irradiation. The reactor is closed, taken out and subjected to microwave irradiation using a CEM Mars microwave oven (2.45 GHz).

A controlled temperature program allows a specific temperature of 140° C. to be reached with a 10 minute ramp and to maintain this temperature for 120 minutes, with a power constraint limited to Pₘₐₓ=60 W. The reaction temperature is then reduced to room temperature and the polymer dissolved in a minimum amount of DCM, then precipitated from 300 mL of methanol with vigorous stirring to remove the unreacted monomers. The methanol is freshened after 2 hours with stirring. After 4 hours, the PTMC-PCL copolymer, obtained in the form of a white gum, named “M10PPA-T”, is dried under vacuum at 80° C. for 48 hours.

The same synthetic protocol is followed for the synthesis of a PTMC60-PCL40 polymer with a theoretical molecular mass of about 50 000 g·mol⁻¹, named “M50PPA-T”, using the following amounts of reagents: TMC (6.037 g, 59.14 mmol; 279.85 equiv.), CL (4.500 g, 39.43 mmol, 186.56 equiv.) and PPA (28.5 μL, 0.21 mmol, 1 equiv.).

The reaction scheme for the synthesis of the M10PPA-T copolymers is shown below.

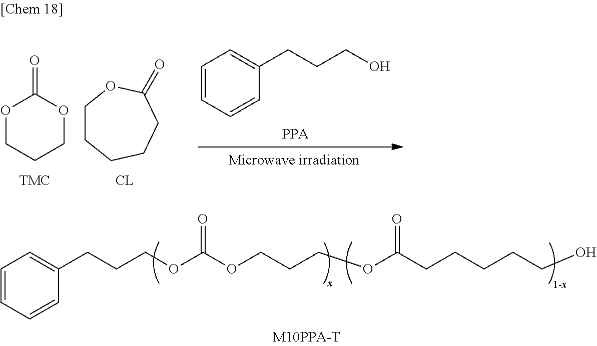

2.3. Synthesis of PTMC-PCL Copolymer by ROP Under Microwave Irradiation, Initiated with PPA, without Catalyst, in the Absence of Solvent

The following protocol is followed for the bulk synthesis (without solvent medium) by ROP, under microwave irradiation, without catalyst, and initiated with a monoalcohol (PPA), of PTMC-PCL, with a theoretical molecular mass of 10 000 g·mol⁻¹.

The monomers TMC (6.037 g; 59.14 mmol, 55.36 equiv.) and CL (4.500 g, 39.43 mmol, 36.91 equiv.) and the initiator PPA (144.0 μL, 1.07 mmol, 1 equiv.) are introduced into an XP1500 PTFE reactor in a glove box filled with argon. The reactor is closed, taken out and subjected to microwave irradiation using a CEM Mars microwave oven (2.45 GHz).

A controlled temperature program allows a specific temperature of 140° C. to be reached with a 10 minute ramp and to maintain this temperature for 120 minutes, with a power constraint limited to Pₘₐₓ=60 W. The reaction temperature is then reduced to room temperature and the polymer dissolved in a minimum amount of DCM, then precipitated from 300 mL of methanol with vigorous stirring to remove the unreacted monomers. The methanol is freshened after 2 hours with stirring.

After 4 hours, the PTMC-PCL copolymer, obtained in the form of a white gum, named “M10PPA”, is dried under vacuum at 80° C. for 48 hours.

The same synthetic protocol is followed for the synthesis of a PTMC60-PCL40 copolymer with a theoretical molecular mass of about 50 000 g·mol⁻¹, named “M50PPA”, using the following amounts of reagents: TMC (6.037 g, 59.14 mmol; 279.85 equiv.), CL (4.500 g, 39.43 mmol, 186.56 equiv.) and PPA (28.5 μL, 0.21 mmol, 1 equiv.).

The reaction scheme for the synthesis of the M10PPA copolymers is shown below.

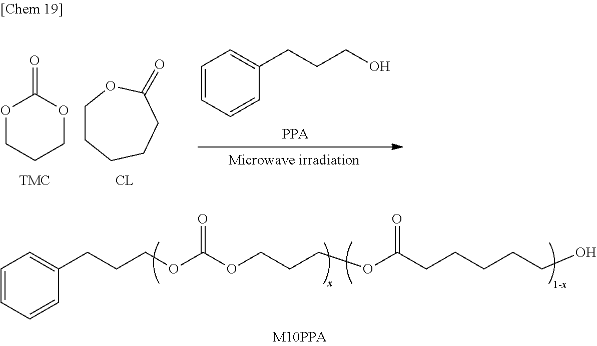

2.4. Protection of the PTMC-PCL Copolymer with Different Protective Agents

In a typical procedure, G10PPA (10.00 g, 0.001 mol, 1 equiv.) was introduced into a 100 ml single-necked round-bottomed flask equipped with a magnetic stirrer in an argon-filled glove box. Distilled DCM (20 ml) was then added to dissolve the polymer. For protection with benzoyl chloride (BC), TEA (1.395 ml, 0.01 mol, 10 equiv.) and BC (1.162 ml, 0.01 mol, 10 equiv.) were introduced and the reaction was allowed to proceed at room temperature for 48 hours. For protection with p-toluenesulfonyl isocyanate (TSI), TSI (1.528 ml, 0.01 mol, 10 equiv.) was introduced and the reaction was allowed to proceed at room temperature for 48 hours.

The reaction mixture was then introduced dropwise into 300 ml of methanol to precipitate the polymer and react with the residual protecting agent. The resulting polymer was washed with methanol until no trace of the byproducts (methyl benzoate, urethane, etc.) was detected by ¹H NMR. The final products, named G10PPA-BC and G10PPA-TSI, the hydroxyl functions of which are protected with benzoyl chloride or p-toluenesulfonyl isocyanate, respectively, were dried under vacuum at 80° C. for 48 hours and stored in a glove box.

The same protocol with the same mole ratio of protecting agent used is used for the protection of the other copolymers (G50PPA, M10PPA-T, M50PPA-T, M10PPA, M50PPA).

The reaction scheme for the protection of P10PPA is shown below.

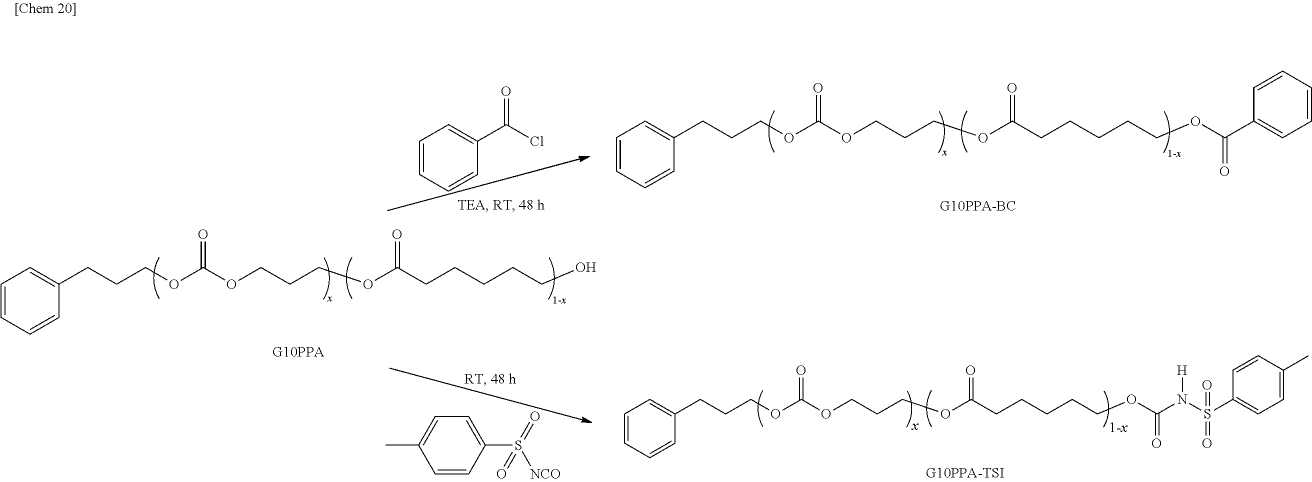

### 2.5. Synthesis of PTMC-PCL Copolymer Using Sn(Oct)₂ as Catalyst (Comparative)

The following protocol is followed for the ROP synthesis, using the catalyst Sn(Oct)₂ and initiated with a monoalcohol (PPA), of the PTMC-PCL copolymer, with a theoretical molecular mass of 10 000 g·mol⁻¹.

The monomers TMC (6.037 g, 59.14 mmol, 55.36 equiv.) and CL (CL, 4.500 g, 39.43 mmol, 36.91 equiv.), the initiator PPA (144.0 μL, 1.07 mmol, 1 equiv.) and a 1 M solution of the catalyst Sn(Oct)₂ dissolved in anhydrous toluene (19.7 μL, 2.0×10⁻² mmol, 0.02 equiv.) are introduced into a 100 mL single-necked round-bottom flask in a glove box filled with argon. The mole ratio of monomer to catalyst [TMC+CL]/[Sn(Oct)₂] is about 5000:1. The flask is closed, taken out and heated to 130° C. using an oil bath with vigorous stirring for 24 hours.

The reaction mixture is then cooled to room temperature and a minimum amount of DCM is added to dissolve the PTMC polymer. The copolymer solution is then poured into 300 mL of cold methanol with vigorous stirring to precipitate the polymer.

The polymer mass, in the form of a white gum, is washed several times with methanol, then dried in an oven at 60° C. followed by vacuum drying at 80° C. for 48 hours to obtain the final product, named “R10-PPA”.

The same synthetic protocol is followed for the synthesis of the PTMC60-PCL40 copolymer with a theoretical molecular mass of 50 000 g·mol⁻¹, named “R50-PPA”, using the following amounts of reagents: TMC (6.037 g, 59.14 mmol; 279.85 equiv.), CL (4.500 g, 39.43 mmol, 186.56 equiv.), PPA (28.5 μL, 0.21 mmol, 1 equiv.) and a 1 M solution of the catalyst Sn(Oct)₂ (19.7 μL, 2.0×10⁻² mmol, 0.093 equiv.). The monomer/catalyst mole ratio [TMC+CL]/[Sn(Oct)₂] is about 5000:1. The reaction time was increased to 48 hours to achieve high monomer conversion.

The reaction scheme for the synthesis of the PTMC-PCL copolymer using the catalyst Sn(Oct)₂ and initiated with PPA is shown below.

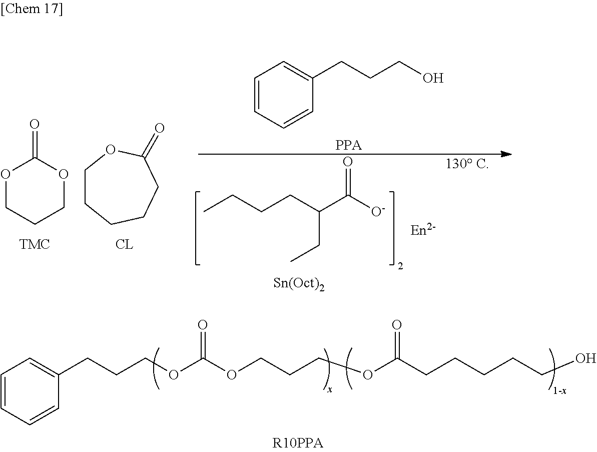

### Results

The results of the analyses of the PTMC-PCL copolymers obtained are presented in table 2 below.

TABLE 2

| | Yield | [TMC]/ | M_{n-SEC} | M_{w-SEC} | |
|---|---|---|---|---|---|
| Sample | (%)^{a} | [CL]^{b} | (Da)^{c} | (Da)^{c} | PDI^{d} |
| R10-PPA | 92 ± 2 | 1.4 | 15600 ± 1500 | 23800 ± 2000 | 1.53 ± 0.03 |
| (Outside the invention) | | | | | |
| R50-PPA | 92 ± 2 | 1.4 | 31300 ± 2500 | 49200 ± 2500 | 1.57 ± 0.03 |
| (Outside the invention) | | | | | |
| G10-PPA | 92 ± 2 | 1.5 | 15500 ± 1000 | 20400 ± 1500 | 1.30 ± 0.02 |
| G50-PPA | 92 ± 2 | 1.4 | 24200 ± 1500 | 30600 ± 2500 | 1.27 ± 0.02 |
| M10PPA-T | 94 ± 3 | 1.4 | 8700 ± 500 | 17700 ± 1000 | 2.03 ± 0.03 |
| M50PPA-T | 94 ± 3 | 1.5 | 18500 ± 1000 | 39600 ± 1500 | 2.14 ± 0.03 |

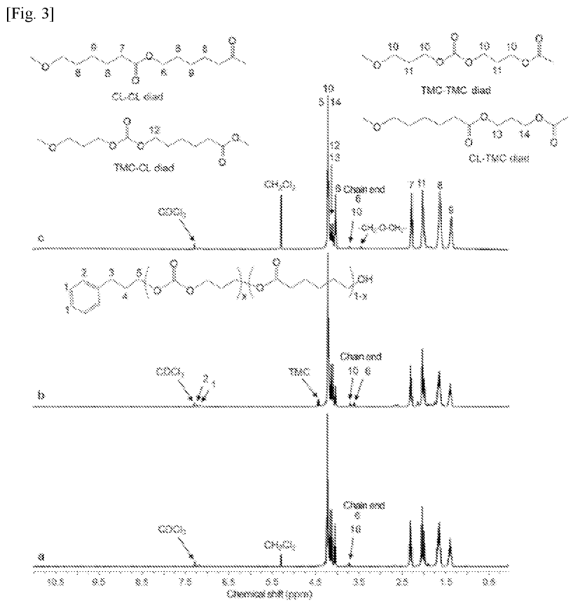

^{a}The conversion yield is calculated from the mass of the resulting PTMC-PCL copolymer (m_{PTMC-PCL}) and the masses of the starting monomers and initiator PPA, according to the formula
yield (%) = m_{PTMC-PCL} × 100/(m_{TMC} + m_{CL} + m_{PPA});
^{b}The experimental mole ratio between TMC and CL monomers, [TMC]/[CL], is evaluated by integration of the peaks numbered 7 and 11 on the ¹H NMR analysis spectra shown in FIG. 3, as reported in publication [8];
^{c}The average molecular mass is measured by SEC;
^{d}Polydispersity index PDI = M_{W}/Mₙ.

The ¹H NMR analyses of the ROP-synthesized PTMC60-PCL40 copolymers (of about 10 000 g·mol⁻¹) initiated with PPA using the catalyst MSA (G10PPA, graph a), the catalyst Sn(Oct)₂ (R10PPA, graph c) or without catalyst using microwave irradiation in the presence of toluene (M10PPA-T, graph b) are shown in FIG. 3.

A small peak at 3.43 ppm (FIG. 3(c)) can also be observed in the ¹H NMR spectrum of the sample R10PPA, which can be attributed to the formation of ether bonds —CH₂—O—CH₂-due to thermal degradation of the polymer at high temperature, as described in Example 1. In contrast, no evidence of ether bonds is observed in the ¹H NMR spectra of the G10PPA and M10PPA copolymers according to the invention (FIG. 3(a) and FIG. 3(b), respectively).

The NMR results thus show that the polymerization, using the catalyst MSA or without catalyst using microwave irradiation, leads to copolymers with fewer defects in their chemical structure than those resulting from synthesis with the catalyst Sn(Oct)₂.

The synthetic route using the catalyst MSA resulted in linear PTMC-PCL copolymers of two distinct molecular weights with high monomer conversion and high polymerization control (closest polydispersity index to 1).

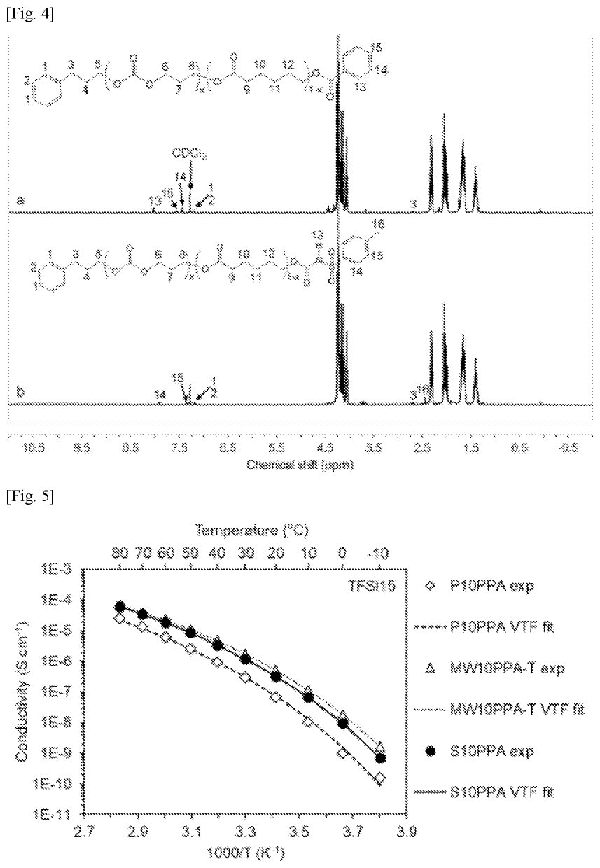

The analyses of the H NMR spectra of the PTMC60-PCL40 copolymers (10 000 g·mol⁻¹), synthesized using the catalyst MSA and the initiator PPA, “protected” with benzoyl chloride (G10PPA-BC) or p-toluenesulfonyl isocyanate (G10PPA-TSI) are shown in FIG. 4.

The appearance of new peaks corresponding to the protecting agents in the ¹H NMR spectra of the protected PTMCs reveals that the protections were successfully achieved using benzoyl chloride and p-toluenesulfonyl isocyanate. In particular, three new peaks, which appear at 8.03, 7.56 and 7.43 ppm (peaks 11, 12 and 13) in FIG. 4(a), are attributed to the three protons on the aromatic ring of benzoyl chloride. In addition, due to the electron-withdrawing effect of the benzoate group attached to the polymer chain, three protons at the end of the polymer chain shift to higher ppm values (peaks 8, 9 and 10 in FIG. 4(a)).

Similarly, two new peaks appearing at 7.89 and 7.34 ppm (peaks 12 and 13 in FIG. 4(b)) correspond to the two protons on the aromatic ring of p-toluenesulfonyl isocyanate. In addition, a very small peak appearing at 8.16 ppm (peak 11 in FIG. 4(b)) is derived from the urethane group proton of the coupling product. Finally, a singlet appearing at 2.44 ppm is derived from the methyl group attached to the aromatic ring of the TSI agent. The ¹H NMR spectra reveal that the coupling reactions were successfully performed.

### Example 3

### Preparation and Evaluation of the Electrochemical Properties of Solid Electrolytes Based on PTMC Polymers and PTMC-PCL Copolymers

The ion conductivity and electrochemical stability properties of solid electrolytes based on PTMC polymers and PTMC-PCL copolymers are evaluated as follows.

### 3.1. Preparation of Solid Polymer Electrolytes (SPEs) Based on PTMC Polymers and PTMC-PCL Copolymers

Protocol for the Preparation of P10PPA-Based Electrolytes with [CO]/[Li⁺] of 15

In an argon-filled glove box, 2.000 g of PTMC, the P10PPA synthesized as described in Example 1, are introduced into a glass vessel equipped with a magnetic bar and 0.370 g of LiTFSI is added. 4 mL of anhydrous acetone are then added, and the mixture is stirred for at least 4 hours to obtain a homogeneous solution. The solution is degassed, coated onto the substrates, and oven dried at 60° C. for 8 hours, followed by vacuum drying at 100° C. for at least 72 hours to obtain the polymer electrolyte, named P10PPA-TFSI15. The mole ratio of the polymer carbonyl groups to the lithium salt, denoted [CO]/[Li⁺], is 15.

Other P10PPA-based electrolytes are prepared with [CO]/[Li⁺] ratios of 0.1; 0.5; 1; 2; 5; 10 and 30.

The same protocol is followed for the preparation of all the “unprotected” and “protected” PTMC-based electrolytes.

To investigate the effect of the counter-anion on the electrolyte properties, other solid polymer electrolytes are also prepared with [CO]/[Li⁺] ratios of 10 and 15, using the same protocol, using as lithium salts, LiFSI and LiTDI.

Protocol for the Preparation of the Electrolytes Based on the G10PPA Copolymer with [CO]/[Li⁺] of 15

In an argon-filled glove box, 2.000 g of G10PPA copolymer, synthesized in Example 2, are introduced into a glass vessel equipped with a magnetic bar and 0.353 g of LiTFSI is added. 4 mL of anhydrous acetone are then added, and the mixture is stirred for at least 4 hours to obtain a homogeneous solution. The solution is degassed, coated onto the substrates, and oven dried at 60° C. for 8 hours, followed by vacuum drying at 80° C. for at least 72 hours to obtain the polymeric electrolyte, named G10PPA-TFSI15.

Other electrolytes based on the G10PPA copolymer are prepared with [CO]/[Li⁺] ratios of 0.1; 0.5; 1; 2; 5; 10 and 30.

The same protocol is followed for the preparation of electrolytes based on the other “unprotected” and “protected” copolymers.

### 3.2. Preparation of Hybrid Solid Electrolytes (HSEs) Based on PTMC Polymers and PTMC-PCL Copolymers

Protocol for the Preparation of Hybrid Solid Electrolytes Based on P10PPA with [CO]/[Li⁺] of 15

In an argon-filled glove box, 2.000 g of PTMC, the P10PPA synthesized as described in Example 1, are introduced into a PTFE vessel equipped with a magnetic bar and 0.370 g of LiTFSI is added. 4.8 mL of anhydrous acetonitrile are then added, and the mixture is stirred for at least 12 hours to obtain a homogeneous solution. Next, the conductive ceramic Li_{1.3}Al_{0.3}Ti_{1.7}P₃O₁₂ (LATP) (1.429 g, about 20% by volume of ceramic relative to the total volume of the electrolyte) is added and the mixture is stirred using a tube blender for 4 hours to obtain a homogeneous suspension. The suspension is degassed, coated onto the substrates, and oven dried at 60° C. for 8 hours, followed by vacuum drying at 80° C. for at least 72 hours to obtain the hybrid solid electrolytes, named P10PPA-TFSI15-LATP20. The mole ratio between the carbonyl groups of the polymer to the lithium salt, denoted [CO]/[Li⁺], is 15.

Other P10PPA-based hybrid solid electrolytes with [CO]/[Li⁺] ratios of 0.5; 1; 2; 5 and 10 containing 20% by volume of ceramic are prepared using the same protocol, named P10PPA-TFSI0.5-LATP20, P10PPA-TFSI1-LATP20, P10PPA-TFSI2-LATP20, P10PPA-TFSI5-LATP20 and P10PPA-TFSI10-LATP20, respectively.

Other P10PPA-based hybrid solid electrolytes with [CO]/[Li⁺] ratios of 0.5; 1; 2; 5; 10 and 15 containing 60% by volume of ceramic are prepared using the same protocol, named P10PPA-TFSI0.5-LATP60, P10PPA-TFSI1-LATP60, P10PPA-TFSI2-LATP60, P10PPA-TFSI5-LATP60, P10PPA-TFSI10-LATP60 and P10PPA-TFSI15-LATP60, respectively.

The same protocol is followed for the preparation of all the “unprotected” and “protected” PTMC-based hybrid solid electrolytes.

Protocol for the Preparation of the Hybrid Solid Electrolytes Based on the G10PPA Copolymer with [CO]/[Li⁺] of 15

In an argon-filled glove box, 2.000 g of G10PPA copolymer, synthesized in Example 2, are introduced into a PTFE vessel equipped with a magnetic bar and 0.353 g of LiTFSI is added. 4 mL of anhydrous acetone are then added, and the mixture is stirred for at least 12 hours to obtain a homogeneous solution. Next, the conductive ceramic Li_{1.3}Al_{0.3}Ti_{1.7}P₃O₁₂ (LATP) (1.420 g, 20% by volume of ceramic relative to the total volume of the electrolyte) is added and the mixture is stirred using a tube blender for 4 hours to obtain a homogeneous suspension. The suspension is degassed, coated onto the substrates, and oven dried at 60° C. for 8 hours, followed by vacuum drying at 80° C. for at least 72 hours to obtain hybrid solid electrolytes, named G10PPA-TFSI15-LATP20.

Other G10PPA-based hybrid solid electrolytes with [CO]/[Li⁺] ratios of 0.5; 1; 2; 5 and 10 containing 20% by volume of ceramic are prepared using the same protocol, named G10PPA-TFSI0.5-LATP20, G10PPA-TFSI1-LATP20, G10PPA-TFSI2-LATP20, G10PPA-TFSI5-LATP20 and G10PPA-TFSI10-LATP20, respectively.

Other P10PPA-based hybrid solid electrolytes with [CO]/[Li⁺] ratios of 0.5; 1; 2; 5; 10 and 15 containing 60% by volume of ceramic are prepared using the same protocol, named G10PPA-TFSI0.5-LATP60, G10PPA-TFSI1-LATP60, G10PPA-TFSI2-LATP60, G10PPA-TFSI5-LATP60, G10PPA-TFSI10-LATP60 and G10PPA-TFSI15-LATP60, respectively.

The same protocol is followed for the preparation of all the “unprotected” and “protected” PTMC-PCL copolymer-based hybrid solid electrolytes.

### 3.3. Evaluation of the Solid Polymer Electrolytes

### Electrolyte Characterization Methods

Ion conductivity: The ion conductivity is determined by Electrochemical Impedance Spectroscopy (EIS) using a VMP3 impedance analyzer (BioLogic) over a temperature range of −10° C. to 80° C. in 10° C. stages. The electrolytes are mounted in button cells in an argon-filled glove box between two stainless-steel blocking electrodes. A PTFE separator (16 mm diameter and 60 μm thick) with a 6 mm diameter hole is used to fix the size and shape of the electrolyte. The cells, preconditioned at 55° C. in an oven for 16 hours, are stabilized at a given temperature for 2 hours before each measurement, and the temperature is controlled using a climate chamber (Vötsch VC4018). The heating and cooling measurements are taken. The impedance spectra are recorded in the frequency range from 1 Hz to 1 MHz. Both PEIS (“Potentio Electrochemical Impedance Spectroscopy”, controlled applied voltage) and GEIS (“Galvano Electrochemical Impedance Spectroscopy”, controlled applied current) modes are used with an applied voltage or current amplitude of 0.02 V or 30 nA, respectively.

The electrolyte membrane resistance (R_{bulk}) is determined via analysis and interpretation of the Nyquist plot from the data obtained with the EC-Lab software. The conductivity is calculated using the following equation:

$$[ Math 2 ]$$

$$σ = \frac{L}{R \times S} \qquad ( equation 1 )$$

where L is the thickness of the electrolyte membrane (cm), S is the surface area of the electrode (cm²) and R is the bulk resistance of the membrane (ohms).

Activation energy: The activation energy (Eₐ) is determined by analyzing the conductivity curves by means of the VTF (Vogel-Tammann-Fulcher) equation [9] using a Solver tool.

$$σ = {Ae}^{\frac{- {E}_{a}}{{R ( T - {T}_{0} )}^{}}} \qquad [ Math 3 ]$$

with σ representing the ion conductivity (S·cm⁻¹), A=σ₀T^{-0.5} is the temperature dependent pre-exponential factor (S·cm⁻¹), Eₐ is the activation energy (J·mol⁻¹), R=8.314 J·mol⁻¹·K⁻¹ is the universal constant of ideal gases; T₀=T_{g}-50 and T is the temperature in Kelvin (K).

The extrapolation of the curves according to the VTF equation was performed only on the cooling curves, and the glass transition temperatures (Tg) of the PTMC and of the copolymer were set at −27° C. ([10], [11]) and −35° C. ([2]), respectively.

Li⁺ ion transport number: The Li⁺ ion transport number (t₊) is measured at 60° C. by EIS via a VMP3 impedance analyzer (BioLogic) on symmetrical Li/electrolyte/Li button cells using the known method of Bruce and Vincent [16]. In particular, t₊ is calculated using equation 3 below:

$${t}_{+} = \frac{{I}_{SS} ( Δ V - {I}_{0} {R}_{0} )}{{I}_{0} ( Δ V - {I}_{SS} {R}_{SS} )} \qquad [ Math 4 ]$$

with ΔV representing the potential applied across the cell, I₀ and I_{SS} are the initial and resting currents while R₀ and R_{SS} are the initial and resting resistances of the stabilizing layers.

Electrochemical stability: The electrochemical stability of the electrolyte membranes is evaluated by cyclic voltammetry (CV) in a button cell comprising the electrolyte intercalated between a lithium metal foil as the counterelectrode and a copper (Cu) or carbon-coated aluminum (Al@C) foil as the working electrode. A PTFE separator as described previously is used to fix the size and shape of the electrolyte.

To determine the anodic stability, Li/SPE/Al@C cells were used. The cells were mounted in an argon-filled glove box, and subjected to cyclic voltammetry measurements using a VMP3 (BioLogic) with a scan rate of 0.1 mV·s⁻¹ from 2.8 to 4.5 V and repeated up to 10 cycles. To determine the cathodic stability, Li/SPE/Cu cells were subjected to CV measurements using a scan rate of 0.1 mV·s⁻¹ from 2.0 to −0.5 V and repeated up to 10 cycles.

### Results

The performance, in terms of ion conductivity (σ), Li⁺ ion transport number (t₊), Li⁺ ion conductivity and activation energy (Eₐ), of the various PTMC and PTMC-PCL based polymeric electrolytes synthesized using different catalysts and different lithium salts, are collated in Table 3 below.

TABLE 3

| | | | Li⁺ | |
|---|---|---|---|---|
| | σ^{a,b} | | σ^{c} | Eₐ |
| Sample | (S cm⁻¹) | t₊^{b} | (S cm⁻¹) | (kJ mol⁻¹) |
| S10PPA-TFSI15 | 1.81 × 1.0⁻⁵ | 0.70 ± 0.02 | 1.27 × 10⁻⁵ | 11.25 |
| (Outside the invention) | | | | |
| P10PPA-TFSI15 | 6.23 × 10⁻⁶ | 0.74 ± 0.02 | 4.61 × 10⁻⁶ | 12.83 |
| P10PPA-FSI15 | 4.93 × 10⁻⁶ | 0.70 ± 0.03 | 3.45 × 10⁻⁶ | 12.96 |
| P10PPA-TDI15 | 3.54 × 10⁻⁶ | 0.59 ± 0.06 | 2.09 × 10⁻⁶ | 12.31 |
| P10PPA-TFSI0.5 | 1.71 × 10⁻⁵ | 0.71 ± 0.03 | 1.21 × 10⁻⁵ | 10.44 |
| P10PPA-TFSI1 | 1.39 × 10⁻⁵ | 0.66 ± 0.03 | 9.19 × 10⁻⁶ | 11.92 |
| P10PPA TFSI5 | 6.67 × 10⁻⁶ | 0.65 ± 0.03 | 4.34 × 10⁻⁶ | 12.93 |
| P10PPA-TFSI10 | 8.04 × 10⁻⁶ | 0.70 ± 0.03 | 5.63 × 10⁻⁶ | 12.31 |
| P10PPA-TFSI30 | 3.83 × 10⁻⁶ | 0.73 ± 0.03 | 2.79 × 10⁻⁶ | 11.19 |
| P50PPA-TFSI15 | 4.50 × 10⁻⁶ | 0.74 ± 0.03 | 3.33 × 10⁻⁶ | 12.94 |
| R10PPA-TFSI15 | 2.55 × 10⁻⁵ | 0.67 ± 0.03 | 1.71 × 10⁻⁵ | 9.12 |
| (Outside the invention) | | | | |
| R50PPA-TFSI15 | 1.85 × 10⁻⁵ | 0.68 ± 0.03 | 1.26 × 10⁻⁵ | 9.66 |
| (Outside the invention) | | | | |
| G10PPA-TFSI15 | 3.73 × 10⁻⁵ | 0.66 ± 0.02 | 2.46 × 10⁻⁵ | 9.40 |
| G50PPA-TFSI15 | 2.90 × 10⁻⁵ | 0.67 ± 0.03 | 1.95 × 10⁻⁵ | 8.42 |
| MW10PPA-T-TFSI15 | 2.37 × 10⁻⁵ | 0.70 ± 0.02 | 1.66 × 10⁻⁵ | 10.55 |
| MW50PPA-T-TFSI15 | 3.52 × 10⁻⁶ | 0.71 ± 0.02 | 2.50 × 10⁻⁶ | 12.95 |
| M10PPA-T-TFSI15 | 4.72 × 10⁻⁵ | 0.50 ± 0.03 | 2.36 × 10⁻⁵ | 9.1.8 |
| M50PPA-T-TFSI15 | 1.68 × 10⁻⁵ | 0.68 ± 0.03 | 1.14 × 10⁻⁵ | 10.51 |

^{a}Adjusted values.
^{b}measured at 60° C..
^{c}Li⁺ ion conductivity obtained by normalizing the total ion conductivity with the transport number, t₊, of the Li⁺ ions

FIG. 5 shows the evolution of the ion conductivity as a function of the temperature, obtained for the solid polymer electrolytes based on PTMC, synthesized in Example 1, using the catalyst MSA (P10PPA-TFSI15) or the catalyst Sn(Oct)₂ (S10PPA-TFSI15), or without catalyst using microwave irradiation in the presence of toluene (MW10PPA-T-TFSI15). No temperature drop is observed for PTMC-based solid polymer electrolytes at reduced temperature, unlike the PEO-based electrolytes, which is probably linked to the highly amorphous morphology of the former ([13]). Thus, all the conductivity curves follow the Vogel-Tammann-Fulcher (VTF) behavior [14] even down to −10° C.

As regards the effect of the synthetic method on the transport properties of the polymer obtained, the SPEs based on PTMC synthesized by microwave irradiation (MW10PPA-T-TFSI15) show higher conductivity at low temperatures than that of the SPE based on PTMC synthesized using an Sn(Oct)₂ catalyst (S10PPA-TFSI15), and the last one shows higher conductivity than that of the SPE based on PTMC synthesized using MSA catalyst (P10PPA-TFSI15) although three of them have a similar t₊ number.

This behavior is considered to derive from the much lower PDI of the P10PPA polymer. The higher PDI value means the lower homogeneity of the Mn, which means that there are more polymer molecules with a much smaller Mn (also called oligomer) in the S10PPA polymer. These low molecular weight polymer molecules act as a plasticizer, which increases the segmental mobility of the PTMC chains. Thus, the conductivity of the S10PPA-TFSI15 electrolytes is less dependent on temperature, which was also revealed by a lower activation energy.

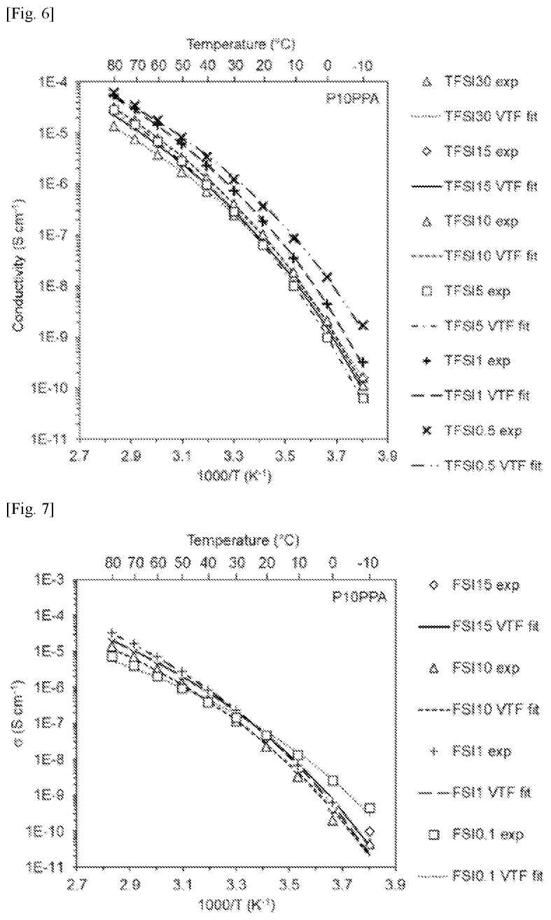

FIG. 6 shows the evolution of the ion conductivity as a function of the temperature for electrolytes based on PTMC synthesized using the catalyst MSA containing different LiTFSI contents, expressed as a mole ratio [CO]/[Li⁺]. At high temperatures above 30° C., it appears that the ion conductivity increases with the salt content. The ion conductivity increases significantly when the [CO]/[Li⁺] ratio decreases to 1 and 0.5, which corresponds to the salt concentration of 73.50 and 84.53 wt %.

FIG. 7 shows the evolution of the ion conductivity as a function of the temperature for electrolytes based on PTMC synthesized using the catalyst MSA containing different LiFSI contents, expressed as a [CO]/[Li⁺] mole ratio.

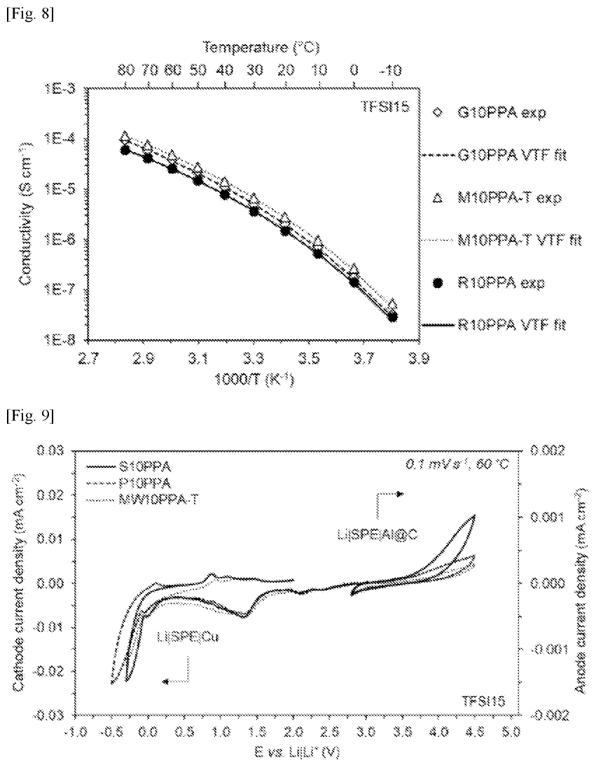

FIG. 8 shows the curves of ion conductivity as a function of the temperature, obtained for the solid polymer electrolytes based on PTMC60-PCL40 copolymer, synthesized in Example 2, using the catalyst MSA (G10PPA-TFSI15) and Sn(Oct)₂ (R10PPA-TFSI15), and using microwave irradiation in the presence of toluene (M10PPA-T-TFSI15).

Compared to PTMC-TFSI electrolytes with a similar molecular mass and a similar salt concentration, the ion conductivity of the polymeric electrolytes based on the PTMC-PCL copolymer (G10PPA) and LiTFSI salt is significantly higher over the entire temperature range (Table 3, FIG. 5 and FIG. 8). The difference in conductivities increases with decreasing temperature.

This behavior can be explained by the higher flexibility of the polymeric chain segments at low temperatures linked to the lower glass transition temperature Tg and to the higher plasticizing effect for the PTMC-PCL copolymer compared to the PTMC homopolymer. The conductivity curves of G10PPA-TFSI15 show VTF behavior down to −10° C. without any drop as may be seen on the conductivity curves of the PCL homopolymer electrolytes 2[15].

Furthermore, the conductivity of G10PPA-TFSI15 is less temperature dependent than that of the P10PPA-TFSI15 electrolyte, as may moreover be seen from the much lower activation energy of the former (9.40 versus 12.83 kJ·mol⁻¹). However, the Li⁺ ion transport number, t₊, of the P10PPA-TFSI15 electrolyte is slightly lower than that of G10PPA-TFSI15, i.e. 0.66 versus 0.74, respectively.

The SPEs based on the PTMC-PCL copolymer synthesized by microwave irradiation (M10PPA-T-TFSI15) show a higher conductivity than that of the SPE based on the copolymer synthesized using as catalyst MSA (G10PPA-TFSI15) or Sn(Oct)₂ (R10PPA-TFSI15).

The electrochemical stability windows of the electrolyte membranes are determined from the first anodic and cathodic scan of the cyclic voltammetry (CV) measurements. FIG. 9 shows the cyclic voltammetry curves obtained for the solid electrolytes P10PPA-TFSI15, MW10PPA-T-TFSI15 and S10PPA-TFSI15 based on the unprotected PTMC synthesized in Example 1 using the initiator PPA.

The results obtained reveal that the anodic stability of the PTMC is highly dependent on the synthetic method. In particular, the PTMC synthesized using a microwave oven without catalyst (MW10PPA-T) is much more stable than the PTMC synthesized using a catalyst (P10PPA and S10PPA). In addition, the PTMC synthesized using the catalyst MSA is more stable than the PTMC synthesized using Sn(Oct)₂ as catalyst. The low oxidation stability of S10PPA is due to the fact that there is Sn(Oct)₂ catalyst remaining in the sample and due to significant defects in the chemical structure.

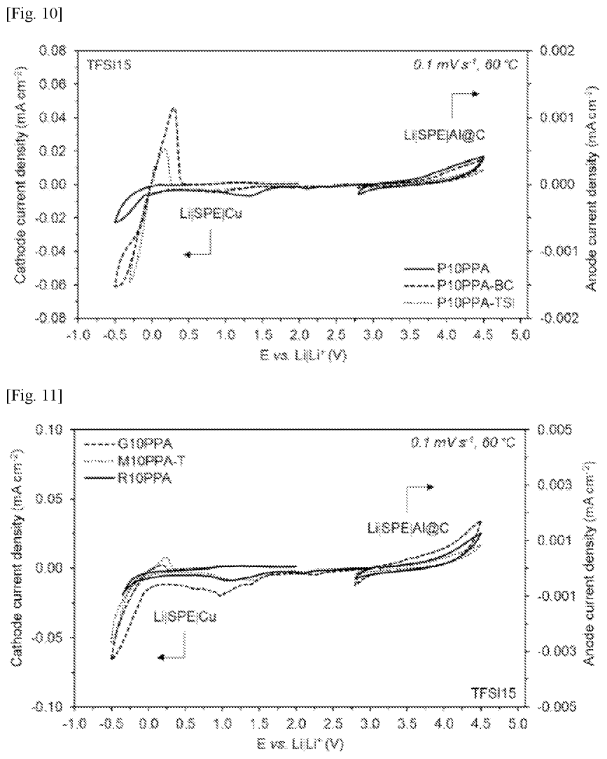

FIG. 10 shows the cyclic voltammetry curves of the solid electrolytes based on unprotected PTMC (P10PPA-TFSI15), and protected PTMC (P10PPA-BC-TFSI15 and P10PPA-TSI-TFSI15), synthesized in Example 1, using the catalyst MSA and the initiator PPA.

The result obtained shows that a great improvement in electrochemical stability was obtained in the electrolytes using PTMC with protected hydroxyl functions compared to that obtained with the electrolyte based on unprotected PTMC. The first scans of the CV measurements reveal the higher stability of the protected polymers with respect to reduction and oxidation. As regards the effect of the protecting agent, the first anodic scans performed on the Li/SPE/Al@C cells show that the benzoyl chloride-protected polymer (P10PPA-BC) is less stable to oxidation than the p-toluenesulfonyl isocyanate-protected polymer (P10PPA-TSI). On the other hand, the first cathodic scans performed on Li/SPE/Cu cells show a much higher stability in contact with the lithium metal anode of P10PPA-BC and P10PPA-TSI as revealed by the appearance of the lithium stripping peak at about 0.25 V against Li/Li⁺. Thus, the coulombic efficiency recorded from the first cathodic scan of P10PPA-BC (27.33%) and P10PPA-TSI (20.38%) is significantly higher than that of virgin P10PPA (8.83%).

FIG. 11 shows the cyclic voltammetry curves obtained for the solid electrolytes G10PPA-TFSI15, M10PPA-T-TFSI15 and R10PPA-TFSI15 based on the unprotected PTMC-PCL copolymer, synthesized in Example 2, using the initiator PPA.

Similarly, the synthetic method also plays an important role in the transport properties of the copolymer electrolytes. The CV results show a higher oxidation stability of the copolymer synthesized using a microwave oven than that obtained using Sn(Oct)₂ as catalyst. Similarly, the low oxidation stability of R10PPA is considered to be due to Sn(Oct)₂ catalyst remaining in the sample and due to defects in the chemical structure.

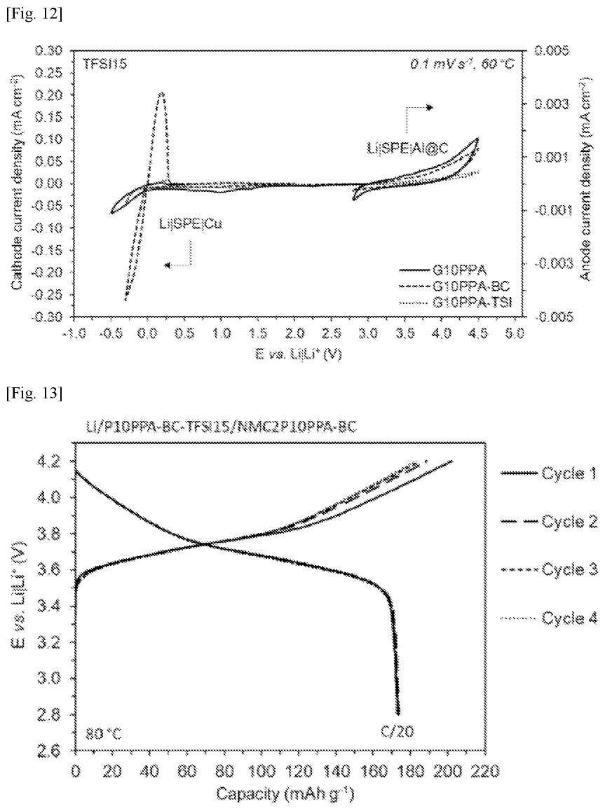

FIG. 12 shows the cyclic voltammetry curves of the solid electrolytes based on the unprotected PTMC-PCL copolymer (G10PPA-TFSI15), and protected PTMC-PCL copolymer (P10PPA-BC-TFSI15 and P10PPA-TSI-TFSI15), synthesized in Example 2, using the catalyst MSA and the initiator PPA. The results show an improvement in the electrochemical stability of the protected polymer. In particular, the protected copolymer is more stable when in contact with the lithium anode.

### Example 4

### Preparation of a Composite Electrode Based on (Co)Polycarbonate and Testing in a Full Battery

The preparation of a composite electrode based on PTMC polymers and PTMC-PCL copolymers and the testing in a complete battery are performed as follows.

### 4.1. Preparation of a Composite Electrode Based on PTMC and PTMC-PCL Copolymer

Li[Ni_{0.6}Mn_{0.2}Co_{0.2}]O₂ (NMC622) based electrodes were prepared by mixing NMC, PTMC or PTMC-PCL copolymer (synthesized as described in Examples 1 and 2), LiTFSI, PVdF and Super P carbon black in a mass ratio summarized in Table 4 in an NMP slurry, which was then cast onto aluminum foil or carbon-coated aluminum foil. The electrode sheets were then predried for 24 hours at 60° C. in an oven. The predried electrodes were cut into 14 mm diameter discs and pressed at 1 tonne for 5 seconds to increase the density of the electrodes. The pressed electrodes were finally dried at 80° C. for 2 days under vacuum. The mass loading of active material was about 2.0 to 2.5 mg·cm⁻². The procedure was performed in an anhydrous room.

The composition of the composite electrodes based on PTMC polymers and PTMC-PCL copolymers (protected and unprotected) is summarized in Table 4 below.

TABLE 4

| | | PTMC or | | | |
|---|---|---|---|---|---|
| | NMC | PTMC-PCL^{a} | LiTFSI | PVdF | Super P |
| Code | (wt %) | (wt %) | (wt %) | (wt %) | (wt %) |
| NMC1P10PPA | 71 | 19 | 4 | 4 | 2 |
| NMC2P10PPA | 77 | 12 | 3 | 4 | 4 |
| NMC1P10PPA-BC | 71 | 19 | 4 | 4 | 2 |
| NMC2P10PPA-BC | 77 | 12 | 3 | 4 | 4 |
| NMC1G10PPA | 71 | 19 | 4 | 4 | 7 |
| NMC2G10PPA | 77 | 12 | 3 | 4 | 4 |
| NMC1G10PPA-BC | 71 | 19 | 4 | 4 | 2 |
| NMC2G10PPA-BC | 77 | 12 | 3 | 4 | 4 |

^{a}Unprotected PTMC, protected PTMC, unprotected PTMC-PCL copolymer, or protected PTMC-PCL copolymer

### 4.2. Preparation of a Complete Battery Containing a Solid Electrolyte and a Composite

Cathode According to the Invention Based on PTMC or PTMC-PCL Copolymer Lithium metal batteries, using as separating electrolyte a solid electrolyte, of the SPE or HSE type as prepared in the previous Example 3, a composite electrode according to the invention as prepared in Example 4.1. as positive electrode, and a lithium metal electrode as negative electrode, are prepared according to the following protocol.

A 16 mm diameter, 60 μm thick polypropylene separator containing an 8 mm diameter hole was placed on the NCM composite electrode (placed beforehand on a 16 mm diameter stainless-steel wedge) and an electrolyte pellet about 8 mm in diameter, prepared as described in Example 3, was fixed in the separating hole. A 14 mm diameter lithium foil (bonded to a 16 mm diameter stainless-steel wedge) was then placed over the electrolyte. The assembly was pressed to 1 tonne for 5 seconds and stacked in a button cell.

### 4.3. Preparation of a Complete Battery Containing a Solid Electrolyte and a Composite Cathode According to the Invention Based on PTMC or PTMC-PCL Copolymer by Direct Coating

Alternatively, the batteries can be prepared by forming a film of solid electrolyte according to the invention directly onto the surface of the positive electrode or the negative electrode, according to the following protocol.

A homogeneous solution or suspension, obtained as described in Example 3, by mixing in a solvent medium PTMC or PTMC-PCL copolymer, a lithium salt and optionally LATP, is coated directly onto a composite electrode, prepared as described in Example 4.1, and onto a lithium metal electrode to form the cathode/solid electrolyte assembly and the anode/solid electrolyte assembly.

The assemblies are predried for 4 hours at room temperature, followed by vacuum drying at 80° C. for at least 72 hours to obtain the cathode/solid electrolyte assembly and the lithium anode/solid electrolyte assembly.

The cathode/solid electrolyte assembly is then used in a button cell in combination with the counterelectrode, either the lithium anode/solid electrolyte assembly or the lithium anode alone.

### 4.4. Evaluation of a Complete Battery Containing a Solid Electrolyte and a Composite Cathode According to the Invention Based on PTMC or PTMC-PCL Copolymer

### Battery Characterization Methods

Galvanostatic cycling of Li/NMC622 cells was performed using an Arbin battery tester with button cells. A discharging/charging rate of 1C corresponds to a specific current of 180 mA·g⁻¹. The potential limits were set between 2.8 and 4.2 V vs. Li/Li⁺ and the cells were maintained at a constant temperature of 80° C.

### Results

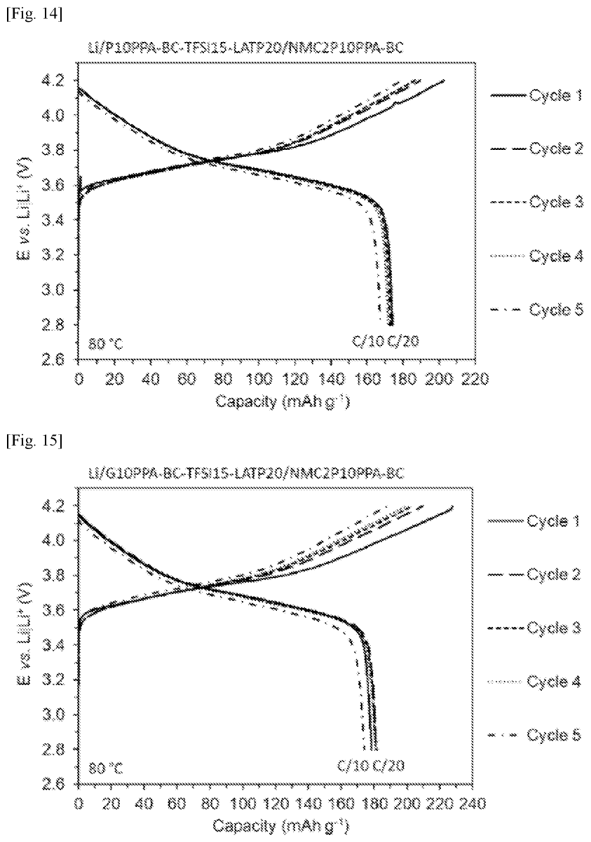

FIG. 13 shows the galvanostatic cycling curves of a complete battery comprising the protected PTMC-based solid polymer electrolyte (SPE) (P10PPA-BC-TFSI15), prepared in Example 3, and the protected PTMC-based composite cathode (NMC2P10PPA-BC), prepared in Example 4.1. The battery was formed according to the protocol described in Example 4.2. The cells provided a reversible discharge capacity of 174 mAh·g⁻¹ in the first four cycles at C/20 accompanied by an initial coulombic efficiency of approximately 85.7%, which then increased to 95% after 4 cycles. The coulombic efficiency increases during cycling without significant loss of capacity.

FIG. 14 shows the galvanostatic cycling curves of a complete battery comprising the protected PTMC-based hybrid solid electrolyte (HSE) (P10PPA-BC-TFSI15-LATP20), as prepared in Example 3, and the protected PTMC-based composite cathode (NMC2P10PPA-BC) prepared in Example 4.2. The battery was formed by direct coating of the electrolyte onto the lithium anode and the composite cathode, as described in Example 4.3. The cells provided a reversible discharge capacity of 174 mAh·g⁻¹ in the first cycle at C/20 accompanied by an initial coulombic efficiency of about 85.9%, which then increased to 92% after 4 cycles. The coulombic efficiency increases during cycling without significant loss of capacity. The reversible discharge capacity is 168 mAh·g⁻¹ in the first cycle at C/10 accompanied by an initial coulombic efficiency of about 93%.

FIG. 15 shows the galvanostatic cycling curves of a complete battery comprising the hybrid solid electrolyte (HSE) based on the protected PTMC-PCL copolymer (G10PPA-BC-TFSI15-LATP20), as prepared in Example 3, and the composite cathode based on the protected PTMC (NMC2P10PPA-BC) prepared in Example 4.2. The battery was formed by direct coating of the electrolyte onto the lithium anode and the composite cathode, as described in Example 4.3. The cells provided a reversible discharge capacity of 178 mAh·g⁻¹ in the first cycle at C/20 accompanied by an initial coulombic efficiency of about 78.4%, which then increased to 91% after 4 cycles. The coulombic efficiency increases during cycling without significant loss of capacity. The reversible discharge capacity is 174 mAh·g⁻¹ in the first cycle at C/10 accompanied by an initial coulombic efficiency of about 92%.

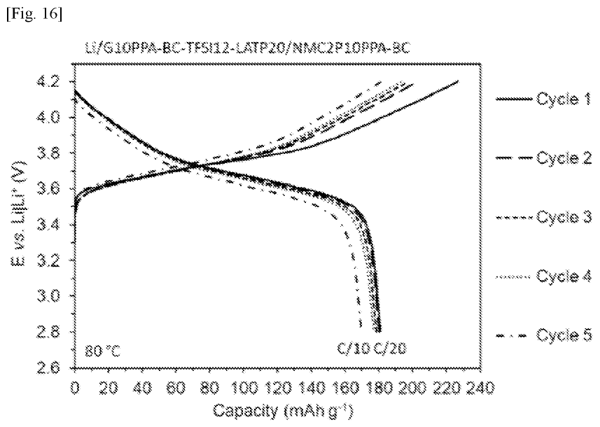

FIG. 16 shows the galvanostatic cycling curves of a complete battery comprising the hybrid solid electrolyte (HSE) based on the protected PTMC-PCL copolymer (G10PPA-BC-TFSI2-LATP20), as prepared in Example 3, and the protected PTMC-based composite cathode (NMC2P10PPA-BC) prepared in Example 4.2. The battery was formed by direct coating of the electrolyte onto the lithium anode and the composite cathode, as described in Example 4.3. The cells provided a reversible discharge capacity of 181 mAh·g⁻¹ in the first cycle at C/20 accompanied by an initial coulombic efficiency of about 79.7%, which then increased to 92% after 4 cycles. The coulombic efficiency increases during cycling without significant loss of capacity. The reversible discharge capacity is 170 mAh·g⁻¹ in the first cycle at C/10 accompanied by an initial coulombic efficiency of about 93%.

### LIST OF CITED DOCUMENTS

[1] Lestriez et al., Comptes Rendus Chim. 13, 1341-1350 (2010);
[2] Zhang et al., J. Power Sources 247, 1-8 (2014);
[3] Shi et al., Acc. Chem. Chem. Res. 50, 2642-2652 (2017);
[4] Pieczonka et al., Adv. Energy Mater. 5, 1501008 (2015);
[5] Sun et al., Solid State Ionics 262, 738-742 (2014);
[6] Mindemark et al., Polymer (Guildfà. 63, 91-98 (2015);
[7] Delcroix et al., Macromolecules 43, 8828-8835 (2010);
[8] Liao et al., Eur. Polym. J. 43, 4289-4296 (2007);
[9] Liao et al., React. Funct. Polym. 68, 751-758 (2008);
[10] Tominaga et al., Electrochim. Acta 302, 286-290 (2019);
[11] Zhu et al., Polym. Degrad. Stab. 97, 1589-1595 (2012);
[12] Tundo et al., Green Chem. 10, 1182-1189 (2008);
[13] Mindemark et al., Prog. Polym. Sci. 81, 114-143 (2018);
[14] Armand et al., Solid State Ionics 69, 309-319 (1994);
[15] Lin et al., Polymer (Guildf). 52, 4106-4113 (2011);
[16] Evans, Polymer, 1987, 28 (13), 2324-2328.

1-20. (canceled)

21. A composite electrode comprising:
at least one solid electrolyte consisting of
one or more (co)polymers obtained by ring-opening (co)polymerization (ROP) of one of:
at least one five- to eight-membered cyclic carbonate, and
at least one five- to eight-membered cyclic carbonate and at least one five- to eight-membered lactone;
said (co)polymerization being catalyzed with methanesulfonic acid or performed under microwave irradiation in an absence of a catalyst;
hydroxyl functions at the end of the chain of said (co)polymer(s) being protected or not protected; and
at least one alkali metal or alkaline-earth metal salt; and
at least one electrode active material.

22. The composite electrode according to claim 21, in which said (co)polymer(s) have a number-average molar mass, Mn, of less than or equal to 200,000 g·mol⁻¹.

23. The composite electrode according to claim 21, in which said (co)polymer(s) have a polydispersity index of less than or equal to 3.5.

24. The composite electrode according to claim 21, in which said (co)polymer(s) are chosen from polytrimethylene carbonate (PTMC) and polytrimethylene carbonate-poly(ε-caprolactone) copolymers (PTMC-PCL).

25. The composite electrode according to claim 21, in which the one or more (co)polymer(s) are obtained by ROP initiated with at least one compound including one or more hydroxyl functions.

26. The composite electrode according to claim 21, in which protected hydroxyl function(s) at the end of said (co)polymer chain result from a reaction of said hydroxyl function(s) with at least one compound.

27. The composite electrode according to claim 21, in which said (co)polymer(s) represent from 5% to 30% by weight relative to a weight of the electrode.

28. The composite electrode according to claim 21, in which the alkali metal or alkaline-earth metal salt is a lithium salt.

29. The composite electrode according to claim 21, in which said active material(s) are chosen:
for a positive composite electrode, from lithium intercalation materials including lithium phosphates; lamellar compounds including lithiated cobalt oxide LiCoO₂, lithiated manganese oxide LiMn₂O₄, and materials based on lithium-nickel-cobalt-manganese LiNiₓMn_{y}Co_{z}O₂ with x+y+z=1 or a material based on LiNiₓCo_{y}Al_{z}O₂ with x+y+z=1, or alternatively spinels; and
for a negative composite electrode, from one of carbon, graphite, lithiated titanium oxide (Li₄Ti₅O₁₂) or titanium niobium oxide (TiNb₂O₇), silicon-based, lithium-based or sodium-based materials, and tin-based materials and alloys thereof.

30. The composite electrode according to claim 21, comprising at least one of:
one or more electrically conductive additives, and
one or more additional binders,
wherein at least one of:
said electrically conductive additive(s) are chosen from carbon fibers, carbon black, carbon nanotubes and mixtures thereof; and
said additional binder(s) are chosen from fluorinated binders, polysaccharides or lattices.

31. The composite electrode according to claim 21, in which wherein at least one of:
said active material(s) represent from 60% to 95% of a weight of the electrode; and
the electrode comprises at least one of:
one or more electrically conductive additives, wherein said electrically conductive additive(s) represent from 1% to 10% of the weight of the electrode; and
one or more additional binders, wherein said additional binder(s) represent from 2% to 7% of the weight of the electrode.

32. An ink for making a composite electrode according to claim 21, comprising, in one or more solvents:
one of the one or more (co)polymers;
at least one alkali metal or alkaline-earth metal salt; and
at least one electrode active material.

33. A process for preparing a composite electrode as defined according to claim 21, comprising at least the following steps:
preparing an ink comprising, in one or more solvents:
one of the one or more (co)polymers,
at least one alkali metal or alkaline-earth metal salt, and
at least one electrode active material; and
forming from said ink, on the surface of a current collector, said composite electrode.

34. The process according to claim 33, in which preparing the ink further comprises:
(i) preparing the one or more (co)polymers; and
(ii) mixing, in one or more solvents, said one or more (co)polymer(s), said at least one of the alkali metal or alkaline-earth metal salt, said at least one electrode active material.

35. The process according to claim 34, in which the preparing in step (i) of the one or more (co)polymer(s) is performed via at least the following steps:
(a1) synthesizing, in a presence or absence of a solvent medium, one or more (co)polymers by ring-opening (co)polymerization of one of:
at least one five- to eight-membered cyclic carbonate, and
at least one five- to eight-membered cyclic carbonate and at least one five- to eight-membered lactone,
said (co)polymerization being catalyzed with methanesulfonic acid and initiated, or not, with at least one compound including one or more hydroxyl functions;
(a2 optionally protecting the hydroxyl functions at the end of the chain of the one or more (co)polymer(s); and
(a3) purifying, prior to or subsequent to step (a2) of protecting the hydroxyl functions, the one of more (co)polymer(s).

36. The process according to claim 34, in which the preparing in step (i) of the one or more (co)polymer(s) is performed via at least the following steps:
(b1) synthesizing the one or more (co)polymers by ring-opening (co)polymerization of one of:
at least one five- to eight-membered cyclic carbonate, and
at least one five- to eight-membered cyclic carbonate and at least one five- to eight-membered lactone;
said (co)polymerization being performed in the absence of a catalyst, under microwave irradiation and initiated with at least one compound including one or more hydroxyl functions;
(b2) optionally protecting the hydroxyl functions at the end of the chain of the one or more (co)polymer(s); and
(b3) optionally purifying, prior to or subsequent to step (b2) of protecting the hydroxyl functions, the one of more (co)polymer(s).

37. An electrode/electrolyte membrane assembly, in which the electrode is a composite electrode as defined according to claim 21.

38. An electrochemical system including a composite electrode as defined according to claim 21, a second electrode which is or is not a composite electrode as defined according to claim 21, and an electrolyte located between the composite electrode and the second electrode.

39. The electrochemical system according to claim 38, the system being a rechargeable battery.

40. The electrochemical system according to claim 38, wherein the electrolyte between the composite electrode and the second electrode is a solid electrolyte film based on one or more (co)polymers as used in the composite electrode.
